(19) United States
(12) Patent Application Publication
(10) Pub. No.: US 2018/0184428 A1
(43) Pub. Date: Jun. 28, 2018

(54) ASSOCIATING AND SECURITIZING DISTRIBUTED MULTI-BAND LINK AGGREGATION DEVICES

(71) Applicants: Laurent CARIOU, Portland, OR (US); Bahareh Sadeghi, Portland, OR (US); Farid Adrangi, Lake Oswego, OR (US); Robert Stacey, Portland, OR (US)

(72) Inventors: Laurent CARIOU, Portland, OR (US); Bahareh Sadeghi, Portland, OR (US); Farid Adrangi, Lake Oswego, OR (US); Robert Stacey, Portland, OR (US)

(21) Appl. No.: 15/392,207

(22) Filed: Dec. 28, 2016

(51) Int. Cl. H04W 72/04

(52) U.S. Cl. CPC H04W 72/0453; H04W 72/0446

(57) ABSTRACT

A device is disclosed that may send at least one beacon to at least one device. The device may identify at least one handshake response received from the at least one device. The device may send a first multiband aggregation request to the at least one device, the multiband aggregation request including a received signal strength indication (RSSI) threshold. The device may identify a multiband aggregation response received from the at least one device, the multiband response including at least one RSSI value. The device may send association and security information associated with at least one second device to at least one third device. The device may send a second multiband aggregation request to the at least one third device. The device may send a data plane transition message to the at least one third device, the data plane transition message including a data plane transition trigger.

### TECHNICAL FIELD

This disclosure generally relates to systems and methods for wireless communications and, more particularly, enhancing the performance of wireless devices by aggregating and utilizing multiple frequency bands.

### BACKGROUND

Wireless devices, such as mobile phones, personal data assistants, laptops, desktop computers, and access points that connect these wireless devices to the internet may operate on different frequencies. As a result some wireless devices may be prevented from connecting to certain access points if the wireless devices do not comprise hardware that will enable the wireless devices to operate at the same frequency at which the access points are operating at New hardware, firmware, middleware, and frequency aggregation techniques needs to be implemented in order to enable wireless devices to connect to access points operating on different frequencies.

### BRIEF DESCRIPTION OF THE DRAWINGS

FIG. 1 depicts a network diagram illustrating an example network environment, according to one or more example embodiments of the disclosure.

FIG. 2A depicts an illustrative logical connection between two access points, according to one or more example embodiments of the disclosure.

FIG. 2B depicts an illustrative logical connection between two wireless radios, according to one or more example embodiments of the disclosure.

FIG. 3 depicts an illustrative authentication timing diagram, according to one or more example embodiments of the disclosure.

FIG. 4 depicts an illustrative data plane connection and management plane connection transfer timing diagram, according to one or more example embodiments of the disclosure.

FIG. 5 depicts an illustrative data plane connection and management plane connection transfer timing diagram, according to one or more example embodiments of the disclosure.

FIG. 6 depicts a flow diagram of an illustrative process for establishing a management plane connection with a device, according to one or more example embodiments of the disclosure.

FIG. 7 depicts a flow diagram of an illustrative process for establishing a management plane connection with an access point, according to one or more example embodiments of the disclosure.

FIG. 8 depicts a flow diagram of an illustrative process for establishing a data plane connection with a device, according to one or more example embodiments of the disclosure.

FIG. 9 depicts a flow diagram of an illustrative process for establishing a data plane connection with an access point, according to one or more example embodiments of the disclosure.

FIG. 10 depicts a flow diagram of an illustrative process for establishing a management plane connection with a device, according to one or more example embodiments of the disclosure.

FIG. 11 depicts a flow diagram of an illustrative process for establishing a management plane connection with an access point, according to one or more example embodiments of the disclosure.

FIG. 12 depicts a flow diagram of an illustrative process for establishing a data plane connection with a device, according to one or more example embodiments of the disclosure.

FIG. 13 depicts a flow diagram of an illustrative process for establishing a data plane connection with an access point, according to one or more example embodiments of the disclosure.

FIG. 14 illustrates a functional diagram of an example communication station that may be suitable for use as a user device, in accordance with one or more example embodiments of the disclosure.

FIG. 15 is a block diagram of an example machine upon which any of one or more techniques (for example, methods) may be performed, in accordance with one or more embodiments of the disclosure.

### DETAILED DESCRIPTION

Example embodiments described herein provide certain systems, methods, and devices, for establishing a spatial reuse channel between to wireless devices.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

For next generation wireless technologies including IEEE 802.11 technologies such as IEEE 802.11ax wave 2, a very compelling technical improvement can be provided by utilizing a technique called multi-band link aggregation. Multi-band link aggregation may provide for simultaneous dual band operation of a wireless device at one or more frequencies (e.g., 2.4 GHz, 5 GHz, and 60 GHz). Multi-band link aggregation may also be applicable to multiple air interfaces in the same band (for example two independent 802.11 ac/ax air interfaces operating at 5 GHz on two different 80 MHz channels). Multi-band link aggregation may include the aggregation of links carrying data associated with either a data plane or management plane.

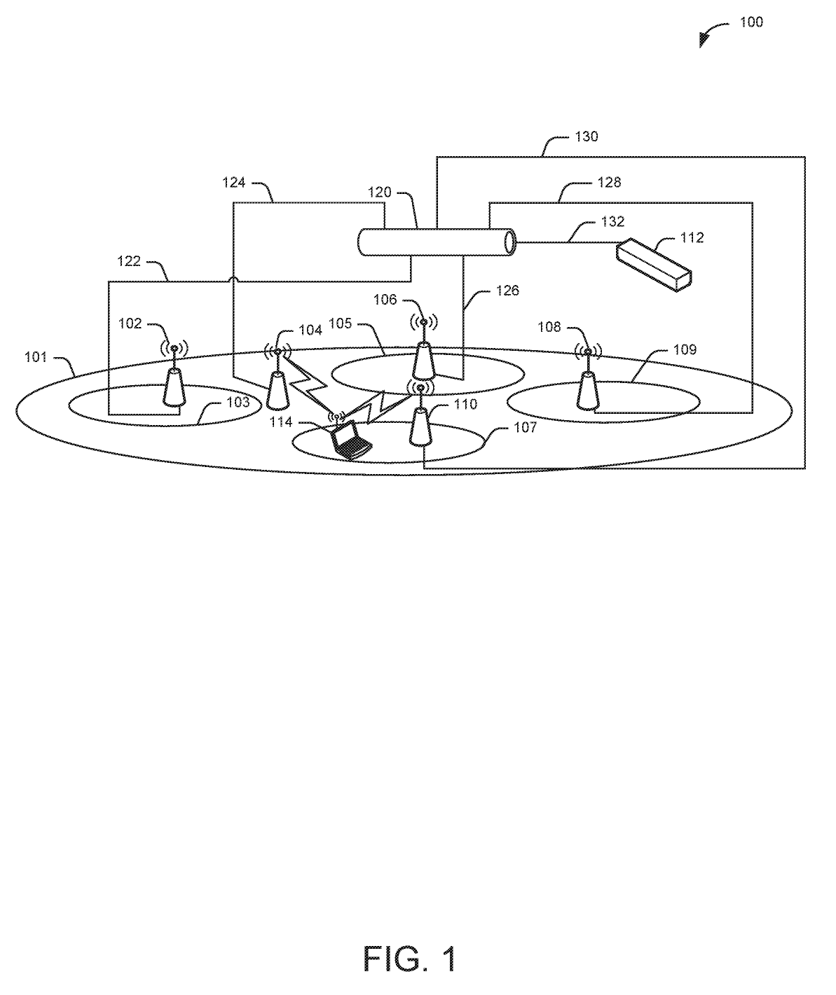

FIG. 1 is a network diagram illustrating an example network environment, according to some example embodiments of the present disclosure. Network 100 may comprise at least one first access point operating at a first frequency (e.g., 60 GHz access point) and at least one second access point operating at a second frequency (e.g., 5 GHz access point) that may be connected to the Internet via a controller, also referred to as a wireless LAN controller. In some embodiments, the at least one first access point and the at least one second access point may be collocated and in other embodiments they may not be collocated. The at least one first access point and the at least one second access point may not be collocated. There may be user devices connected to the at least one first access point and the at least one second access point, and the user devices connected to the at least one first access point may comprise a first basic service set (BSS) and the user devices connected to the at least one second access point may comprise a second basic service set (BSS). The controller may manage the configuration of the at least one first access point and the at least one second access point including determining settings for the at the at least one first access point and the at least one second access point to reduce interference that the at least one first access point and the at least one second point may be causing to other wireless devices within their vicinity. For example, the controller may determine based on reports generated by the at least one first and second access points that the power levels should be adjusted to better accommodate the user devices (e.g., increase power to cover a larger area thereby providing access to more users). The controller may also determine, based on the reports, different channel assignments that may be used by the user devices to connect to the at least one first and second access points. The controller may also manage the configuration of the at least one first access point and the at least one second access point by determining settings that govern the amount of data that the at least one first access point and the at least one second access point can send to and/or receive from the Internet (e.g., load balancing). For example, the controller may enable the at least one first and second access points to enable high-speed load balancing which may enable an user device to connect to multiple access points at the same time for better coverage and data rates. In order to do this though, the user device may need to be authenticated by the controller, via the access points, using an authentication, authorization, and accounting (AAA) protocol such as IEEE 802.1X, as explained below.

Access points 102, 106, 110, and 108 may all operate at a first frequency and may form four BSSs each of which is associated with user devices within footprints 103, 105, 107, and 109, respectively. Footprints 103, 105, 107, and 109 are areas of electromagnetic radiation corresponding to a range within which radio frequency (RF) signals that may be sent by the access points to the user devices in the corresponding BSSs, and RF signals may be sent from the user devices to the access points in the corresponding BSSs. Access point 104 may also operate a second frequency, that may be different from the first frequency, and may have corresponding footprint 101. Footprint 101 may be an area of electromagnetic radiation corresponding to a range within which RF signals that may be sent by access point 104 to user devices within the BSS associated with footprint 101, and RF signals may be sent from the user devices to access point 104. Access points 102, 104, 106, 108, and 110 may be connected to a controller 112 by, for example, wired connections 122, 124, 126, 128, and 130 respectively, and backhaul network 120. Controller 112 may possess one or more of the controller characteristics and or perform one or more of the controller actions described above. In some embodiments, controller 112 may be an authentication server (AS), and may be responsible for authenticating access point s102, 104, 106, 108, and 10 using, for example, the 802.1x authentication protocol. Backhaul network 120 may be a network connecting access points 102, 104, 106, 108, and 110 to each other and controller 112. Wired connections 122, 124, 126, 128, and 130 may be an Ethernet connection. User device 114 may be a mobile device such as a laptop, smartphone, tablet, etc. and may be moved from one BSS to another as a user moves from one location to another. User device 114 may comprise a first radio configured to connect to access point 104 on a 5 GHz frequency, and may also comprise a second radio configured to connect to access point 110 on a 60 GHz frequency. In some embodiments, information associated with a data plane may be sent and received using the first radio and information associated with a management plane may be sent or received using the second radio. Data plane data may comprise protocols that move bits from one location to another, and are concerned with moving frames from input interfaces to output interfaces. For example, in an IP network, the data plane protocols may comprise a transport layer protocol, such as Transmission Control Protocol (TCP), and a network layer protocol, such as Internet Protocol (IP), with applications such as Hypertext Transport Protocol (HTTP) or File Transport Protocol (FTP) on top of the network and transport layers. Management plane data may comprise provides protocols that allow network administrators to configure and monitor network elements. For example, in an IP network, Simple Network Management Protocol (SNMP) may be a management plane protocol. For instance, controller 112 may use a Control and Provisioning of Wireless Access Points (CAPWAP) as a transport protocol to manage access points 102, 104, 106, 108, and 110. Without exception, large-scale IP networks such as WLANs accessible by the public may use centralized management and thus may have a centralized management plane. The management plane of the network is responsible for planning and implementation, policy definition, and monitoring of the access points in a WLAN.

The first radio may be used to send or receive information to and from access point 104 because the information associated with the management plane may not comprise Quality of Service (QoS) or latency sensitive information and therefore is sent or received using a lower frequency than that of the second radio. The second radio may be used to send or receive information from access point 110 because the information associated with the data plane may comprise QoS or latency sensitive information and therefore is sent or received using a higher frequency radio than that of the first radio. Because the first radio operates at a lower frequency the corresponding footprint (footprint 101) over which it may send or receive information to access point 104 may be larger than that of the second radio which may send or receive information to access point 110 within footprint 107.

As an example, the first radio in user device 114 may establish a connection with access point 104 first and access point may send a request to controller 112 via connection 124 to be authenticated, after which access point 104 may provide a connection between the first radio and controller 112 so that the first radio can be authenticated by controller 112. After controller 112 authenticates the first radio, controller 112 may send a message to the first radio recommending at least one access point operating on a 60 GHz frequency that the second radio can connect to (for example, access point 110). The first radio may then communicate to the second radio the at least one access point (for example, access point 110) that the second radio should connect to. The second radio may then open at least one port on a wireless interface of the second radio and tune at least one receiver or transceiver to a 60 GHz frequency and determine if a basic service set identifier (BSSID) broadcast by access point 110. The second radio may measure the received signal strength from access point 110, and may communicate a measurement of the received signal strength (e.g., received signal strength indicator (RSSI)) to the first radio. The first radio may then send a message access point 104 with the BSSID of access point 110 and access point 104 and the first radio may communicate a cryptographic key to access point 110 and the second radio respectively. The first radio may send a signal to the second radio and access point 104 may send a signal to access point 110 indicating that data associated with a data plane should be transmitted between the second radio and access point 110. For instance, the second radio and/or access point 110 may implement one or more protocols that enable the second radio and/or access point 110 to transmit and receive frames comprising a plurality of bits between the second radio and access point 110. In some embodiments, a transmission control protocol (TCP) may be used to transmit and receive frames between the second radio and access point 110. For example, for an application being executed by a processor in user device 114 that requires a connection based transport protocol to be established between the processor and a processor associated with another device, TCP may be used. For instance, if the application is a web browser, an e-mail application, or file transfer application then TCP may be used. In other embodiments, a user datagram protocol (UDP) may be used to transmit and receive frames between the second radio and access point 110. For example, for an application being executed by a processor in user device 114 that does not require a connection based transport protocol to be established between the processor and a processor associated with another device, UDP may be used. For instance, if the application is a streaming video and/or audio service then UDP may be used to stream the service between the processor and a processor associated with a device hosting the streaming video and/or audio service.

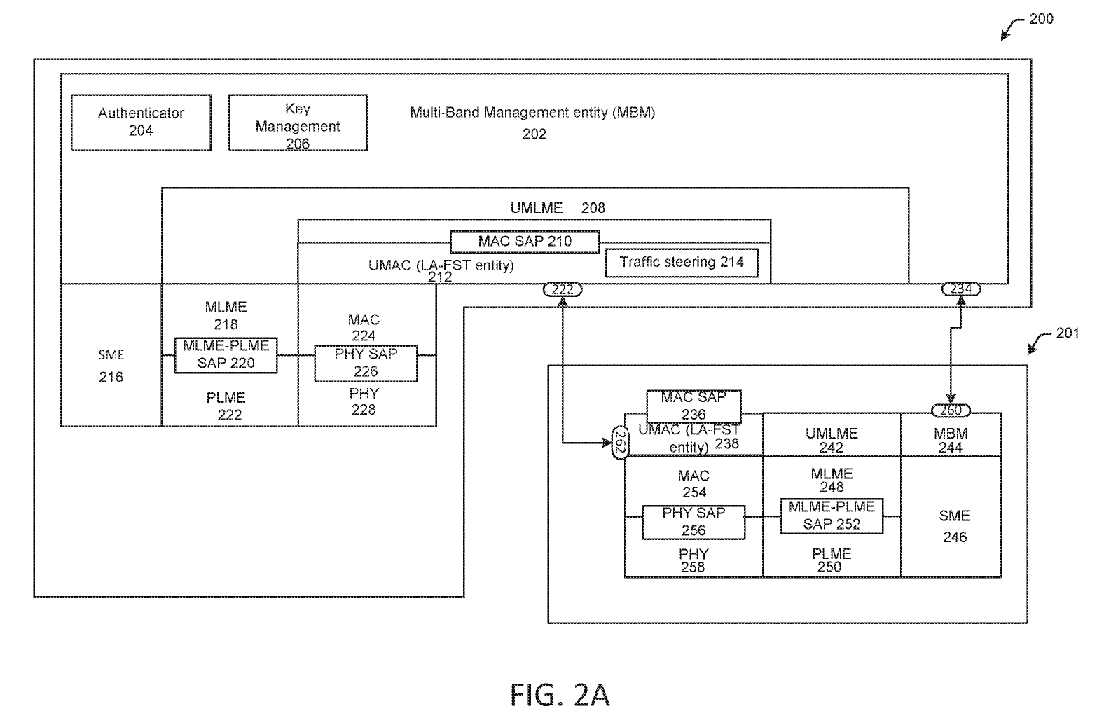

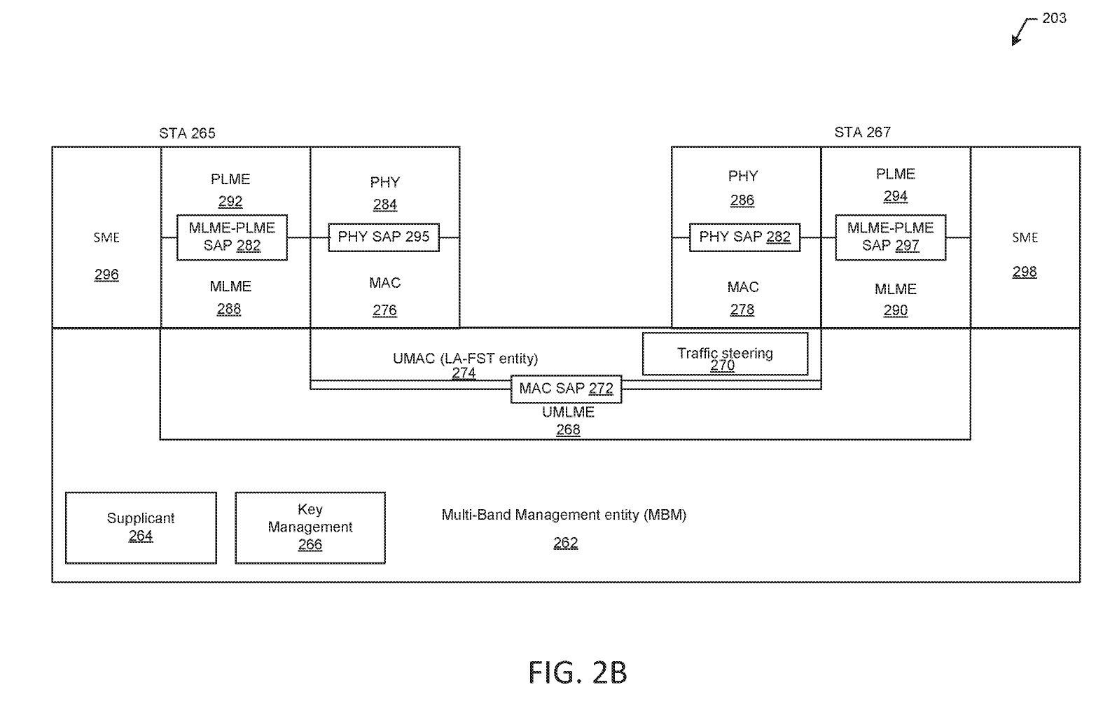

FIG. 2A depicts an illustrative logical connection between two access points, according to one or more example embodiments of the disclosure. Access point 200 may comprise one or more hardware components, firmware that may be executed by a processor that may cause the one or more hardware components to perform certain actions, and/or non-permanent software that may be executed by the processor that may cause the one or more hardware components to perform certain actions consistent with the disclosure herein or modifications to the actions consistent with the disclosure herein. Access point 200 may be referred to as a multi-band capable device.

Access point 200 may comprise a Multi-Band Management (MBM) entity 202 that may be responsible for setting up, configuring, removing, or transferring fast session transfer (FST) sessions established on a first band/channel associated with first radio (e.g., PHY 228) to a second band/channel associated with a second radio (e.g., PHY 258) in access point 201. MBM entity 202 may be implemented in an application specific integrated circuit (ASIC), may coincide with one or more instructions executed by a processor, or may be a software defined radio (SDR) chipset.

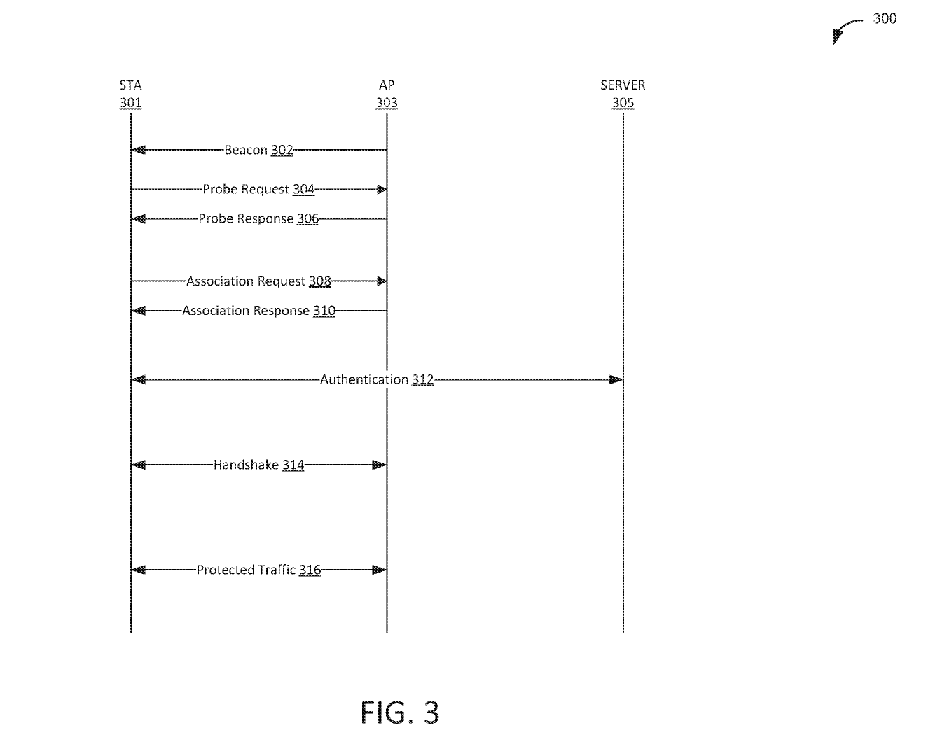

Access point 200 may comprise upper media access control sublayer management entity (UMLME) 208. UMLME 208 may establish connections between access point 200 and a UMLME, for example UMLME 268, in a wireless device such as wireless device 203, an example of which is illustrated in FIG. 3. UMLME 208 may comprise one or more hardware components, firmware that may be executed by a processor that may cause the one or more hardware components to perform certain actions, and/or non-permanent software that may be executed by the processor that may cause the one or more hardware components to generate or receive media access control (MAC) frames from wireless devices. The MAC frames that UMLME 208 may produce may be frames associated with registering wireless devices. The frames associated with registering wireless devices (registration frames) may be transmitted quasi-periodically by access point 200 in order to establish a timing synchronization function (TSF). The registration frames may include fields comprising a basic service set identification (BSS-ID), timestamp (for synchronization), traffic indication map to indicate when a wireless station should enter into low power mode if traffic is data is not available for it, and a field for roaming data. The registration frames may be transmitted as beacon frames to the wireless devices which may in turn measure the received signal strength (RSS) associated with the received beacon frames.

UMLME 208 may also associate and/or disassociate wireless devices that attempt to connect and disconnect to access point 200 as the wireless devices roam from a BSS not associated with access point 200 to a BSS associated with access point 200. UMLME 208 may broadcast at least one handoff beacon frame periodically to the wireless stations and the strongest beacon may be detected by the wireless devices. The handoff beacon frame may comprise fields including a timestamp, beacon interval, capabilities of access point 200, extended service set (ESS) ID, and traffic indication map (TIM). UMLME 208 may receive probe requests from the wireless devices and may send probe responses to the wireless devices in return, comprising the same information in the handoff beacon frame excluding the TIM. UMLME 208 may then receive a re-association request comprising information about the wireless devices and information about another UMLME associated with another access point that the wireless devices are being handed over from.

Access point 200 may comprise a media access control-service access point (MAC-SAP) 210 which may comprise one or more hardware components, firmware that may be executed by a processor that may cause the one or more hardware components to perform certain actions, and/or non-permanent software that may be executed by the processor that may cause the one or more hardware components to send and receive signals between UMLME 208 and upper media access control link aggregation (UMAC LA-fast session transfer FST entity) 212 corresponding to messages associated with fast session transfers of connections from first radio (e.g., PHY 228) to second radio (e.g., PHY 258). A session associated with a fast session transfer may comprise state information stored in a first memory associated with first radio (e.g., PHY 228) and a second memory associated with second radio (e.g., PHY 258). First radio (e.g., PHY 228) may communicate with second radio (e.g., PHY 258) via MBM 202. The state information may be stored in the first memory and the second memory before and after the fast session transfer. The state information may comprise block acknowledgement agreement messages, traffic stream (TS) information corresponding to data streams associated with the first and second radios, association state information, robust security network association (RSNA) information, security keys, sequence counter information, and packet number (PN) information, associated with first radio (e.g., PHY 228) and second radio (e.g., PHY 258).

Access point 200 may comprise authenticator 204 which may comprise one or more hardware components, firmware that may be executed by a processor that may cause the one or more hardware components to perform certain actions, and/or non-permanent software that may be executed by the processor that may cause the one or more hardware components to authenticate wireless devices, such as wireless device 203. Authenticator 204 may comprise an authenticated port that may comprise a controlled logical port and an uncontrolled port either of which may be implemented in firmware or hardware. The controlled port may be controlled by a port access entity (PAE), such as IEEE 802.1x, that may be implemented in firmware to allow authorized data into the controlled port, and may prevent the ingress of unauthorized data to the controlled port or the egress of unauthorized data from the controlled port. The uncontrolled port may be used by PAE to transmit and receive frames comprising authorized data to and from a supplicant in a wireless device. The frames may be implemented using an extensible authentication protocol over local area network (EAPOL) frames. The EAPOL frames may be EAPOL-key frames which may carry EAPOL protocol data unit (PDU) comprising a field corresponding to all or part of an EAPOL-Key type. The EAPOL-Key frames may be used to perform a 4-way handshake in order to confirm that a pairwise management key (PMK) between wireless devices that are associated (wireless devices that have an association ID associated with the access point, or BSS, stored in memory) is the same and that the wireless devices are using it to encrypt frames sent to access point 200 and in particular station management entity (SME) 216. The 4-way handshake may also be performed to transfer a group temporal key (GTK) which may be a random value, assigned by a group source, which may be used to protect group addressed medium access (MAC) protocol data units (MPDUs) from that source. In some embodiments the group temporal key may be derived from a group master key (GMK) which may be an auxiliary key that may be used to generate the GTK. The EAPOL-Key frames may also be used to implement a group key handshake to update the GTK at one or more wireless devices. The EAPOL-Key frames may also be used to implement a peer key initial station-to-station link (STSL) master key (SMK) handshake wherein the SMK may be a random value generated by access point 200, an in particular by, during a SMK handshake. The SMK may be used to derive a STSL transient key (STK). The SMK handshake may include an exchange in which the SMK is transmitted by access point 200 to one or more wireless devices. The EAPOL-Key frames may also be used to implement an exchange associated with a final 4 way STK handshake in order to deliver the STK to an initiating and peer wireless device. The supplicant (wireless devices) may comprise corresponding authenticated port controlled and uncontrolled ports to exchange the EAPOL frames with the controlled and uncontrolled ports of access point 200.

The four-way handshake may be designed so that the access point (or authenticator) and wireless device (or supplicant) can independently prove to each other that they know the PMK, without ever disclosing the key (PMK). Instead of disclosing the key, the access point and wireless device may each encrypt messages to each other—that can only be decrypted by using the PMK that they already share—and if decryption of the messages is successful, this proves knowledge of the PMK. The four-way handshake is critical for protection of the PMK from malicious access points—for example, an attacker's SSID impersonating a real access point—so that the wireless device never has to disclose the PMK to the access point. A wireless device may generate the PMK after it is authenticated. The PMK may be derived by the wireless device based at least in part on one or more of the EAP parameters disclosed herein, provided by the AAA server.

The PMK is designed to last the entire session and may be exposed as little as possible, therefore, the keys to encrypt the traffic need to be derived. A four-way handshake is used to establish another key called the Pairwise Transient Key (PTK). The PTK is generated by concatenating the following attributes: PMK, AP nonce (ANonce), STA nonce (SNonce), AP MAC address, and STA MAC address. The product may then be put through a pseudo random function. The handshake may also yield a Group Temporal Key (GTK), used to decrypt multicast and broadcast traffic.

Authenticator 204 may authenticate wireless devices (supplicants) requesting to be associated with access point 200. When supplicants are detected by SME 216, described below, the authenticated port is enabled and set to an unauthorized state. In this state 802.1x data is allowed, and other data, such as Internet Protocol (IP) and Transmission Control Protocol (TCP) data or User Datagram Protocol (UDP) data may be ignored. Authenticator 204 may periodically transmit EAP-request Identity frames to a special Layer 2 address, and supplicants may open an authenticated port, and in particular an uncontrolled port of the authenticated port, to receive the EAP-request Identity frames. This may be referred to as initialization of authentication of the supplicants.

After the supplicants receive the EAP-request Identify frames the supplicants may transmit an EAP-response Identity frame comprising an identifier associated with the supplicants such as a user ID. Authenticator 204 may then encapsulate the EAP-response Identity frame in an authentication, authorization, and accounting (AAA) Access Request packet and may forward the encapsulated EAP-response Identity frame to an AAA server. In some embodiments, the AAA server may be a remote authentication dial-in user service (RADIUS) server. In some embodiments, the supplicants may also initiate or restart authentication by transmitting an EAPOL-Start frame to authenticator 204, which may reply with an EAP-Request Identity frame. After authenticator 204 transmits the encapsulated EAP-response Identity frame to the AAA server, authenticator 204 may receive an EAP Request frame encapsulated in an AAA access challenge packet from AAA server, and the EAP Request may include the EAP method used by the AAA server to authenticate supplicants. This may be referred to as an initiation of the authentication of the supplicants. In some embodiments, the EAP method may include EAP-MD5, EAP-POTP, EAP-GTC, EAP-TLS, EAP-IKEv2, EAP-SIM, EAP-AKA and EAP-AKA′. In other embodiments, the EAP method may include EAP-TLS, EAP-SIM, EAP-AKA, LEAP and EAP-TTLS. Yet still in other embodiments, vendor specific EAP methods may be used for the EAP method.

Authenticator 204 may encapsulate the EAP request in an EAPOL frame and transmit it to the supplicants. After the supplicants receive the EAP request the supplicants may start using the EAP method indicated in the EAP request. In some embodiments, the supplicants may transmit an EAP frame in an EAPOL frame to authenticator 204 which may in turn transmit the EAP frame to the AAA server in an AAA packet, wherein the EAP frame includes a negative acknowledgment (NAK) indicating the EAP methods that the supplicants want to perform. In some embodiments, a first supplicant may perform a first EAP method, and a second supplicant may perform a second EAP method. This may be referred to as the negotiation of the authentication method used to authenticate the supplicants.

After the supplicants and the AAA server agree on an EAP method, the supplicants may transmit EAP requests to the AAA server, in EAPOL frames and authenticator 204 may extract the EAP requests and encapsulate the EAP requests in AAA Request packets and transmit the EAP requests to the AAA server. Authenticator 204 may then receive AAA Response packets, from the AAA server comprising an EAP success message, which may in turn be encapsulated in an EAPOL frame and transmitted to the supplicants. The EAP success message may indicate that the supplicants have been authenticated. After the EAP success message is received, authenticator 204 may open the controlled port to the supplicants so that data can be sent between the supplicants and the AAA server or other (first) supplicants that have been authenticated by the AAA server to communicate with the supplicants.

Key management 206 may comprise one or more hardware components, firmware that may be executed by a processor that may cause the one or more hardware components to perform certain actions, and/or non-permanent software that may be executed by the processor that may cause the one or more hardware components to send and receive signals or messages to authenticator 204. Key management 206 may be implemented using a 4-Way Handshake, Group Key Handshake, and PeerKey Handshake as defined in IEEE 802.11 with access points or wireless stations. For example, a 4-Way Handshake or Group Key Handshake may be implemented between authenticator 204 and supplicant 264 using one or more keys stored or generated in key management 206.

Access point 200 may comprise media access control (MAC) service access point (SAP) 210 which, may comprise one or more hardware components, firmware that may be executed by a processor that may cause the one or more hardware components to perform certain actions, and/or non-permanent software that may be executed by the processor that may cause the one or more hardware components to send and receive signals or messages between UMLME 208 and UMAC licensed access/link aggregation-fast session transfer (LA-FST) entity UMAC (LA-FST entity) 212. For example, MAC-SAP 210 may receive MAC frames associated with the data plane, and may transmit the MAC frames to a wireless device via PHY 228. In particular, traffic steering 214 may receive MAC frames, associated with the data plane, from a processor executing applications, and may steer the MAC frames to PHY 228 by transmitting a message or signal to UMAC (LA-FST entity) 212 which will in turn transmit a message or signal to MAC 224 indicating that a signal corresponding to the MAC frames should be transmitted on PHY 228 using one or more service primitives associated with PHY SAP 226. MAC SAP 210 may comprise an ASIC enabling UMLME 208 to send one or more signals or messages (e.g., primitives) to UMAC (LA-FST entity) 212, and vice versa, that may enable UMLME 208 and UMAC (LA-FST entity) 212 to communicate. For example, UMLME 208 may correspond to a first ASIC and UMAC (LA-FST entity) 212 may correspond to a second ASIC and MAC SAP 210 may correspond to a third ASIC that may enable UMLME 208 and UMAC (LA-FST entity) 212 to communicate.

Access point 200 may comprise UMAC (LA-FST entity) 212 which, may comprise one or more hardware components, firmware that may be executed by a processor that may cause the one or more hardware components to perform certain actions, and/or non-permanent software that may be executed by the processor that may cause the one or more hardware components to send and receive signals or messages between media access control service access point (MAC SAP) 210 and Traffic Steering 214. UMAC (LA-FST entity) 212 may store MAC or logic link layer state information (non-physical layer state information) about access point 200 and access point 201, and the information shared between access point 200 and access point 201. This information may be referred to session information. In particular, UMAC (LA-FST entity) 212 may transfer a session from access point 200 to access point 201 where access point 200 operates at first frequency and access point 201 operates at a second frequency. For example, there may be a first oscillator in physical layer (PHY) 228 of access point 200 that may oscillate at a frequency of 5 GHZ, and there may be a second oscillator in physical layer (PHY) 258 of access point 201 that may oscillate at a frequency of 60 GHz, and UMAC (LA-FST entity) 212 may determine which physical layer to transfer the session to. In some embodiments UMAC (LA-FST entity) 212 may receive messages or signals from Traffic Steering 214 to transfer data associated with the data plane to PHY 228 and may receive messages or signal from Traffic Steering 214 to transfer data associated with the management plane to PHY 258.

Access point 200 may include a station management entity (SME) 216 which, may comprise one or more hardware components, firmware that may be executed by a processor that may cause the one or more hardware components to perform certain actions, and/or non-permanent software that may be executed by the processor that may cause the one or more hardware components to send and receive signals or messages from PHY 228, as well as any changes in an operating channel, (e.g., using information obtained from out-of-band communication over-the-air frame exchanges). SME 216 is a cross-layer entity that may internally communicate with multiple layers. For example, SME 216 may communicate with MLME 218 and PLME 222 through a service access point (SAP) not shown. In some embodiments, SME 216 may have an interface application layer as well. SME 216 monitors and controls the operation of access point 200. An operator of access point 200 may control the operation of the device (e.g., specifying a SSID, BSSID, channel numbers, security keys, change the status of the device, adjust the received signal strength (RSS) threshold etc.) by issuing a series of commands, and SME 216 will send and/or receive signals or message to and/or from MLME 218 and PLME 222 in order to execute the commands. As an example, SME 216 may provide key management via an exchange of EAPOL-Key frames between Key Management 206 and Authenticator 204.

Access point 200 may comprise traffic steering 214 which, may comprise one or more hardware components, firmware that may be executed by a processor that may cause the one or more hardware components to perform certain actions, and/or non-permanent software that may be executed by the processor that may cause the one or more hardware components to send and receive signals or messages from UMAC (LA-FST entity) 212. Traffic steering 214 may control data associated with the management plane. In particular, traffic steering 214 may determine whether management plane frames should be transmitted via PHY 228 or PHY 258. In some embodiments, traffic steering 214 may determine that management plane frames should be transmitted via PHY 228 associated with an oscillator oscillating at a lower frequency (e.g., 5 GHZ).

SME 216 may sends and receives signals or messages from entities (e.g., MBM, 202, authenticator 204, key management 206, UMLME 208, MAC SAP 210, UMAC (LA-FST entity) 212, traffic steering 214, mac layer management entity (MLME) 218, mac layer management entity (MLME)-physical layer management entity (PLME) service access point (SAP) 220, physical layer management entity (PLME) 222, media access control (MAC) 224, physical layer (PHY) service access point (SAP) 226, and/or physical layer (PHY) 228). SME 216 may determine PHY 228 parameters, as well as any changes in the operating channel, for example, using information obtained via out-of-band communication or over-the-air frame exchange. In some embodiments, MBM 202 may be a circuit (e.g., application specific integrated circuit (ASIC)) within SME 216. In some embodiments, SME 216 may perform the actions of an authenticator, and optionally the supplicant and authentication server actions. For example, in an independent basic service set (IBSS), SME 216 may perform supplicant and authenticator actions and might also perform authentication server actions as well.

SME 216 may determine certain measurements associated with a channel on PHY 228 and/or PHY 258, and may determine whether to switch PHY 228 and/or PHY 258 to a different channel. For example, SME 216 may cause to send a signal or message to MLME 218 requesting a channel measurement (e.g., channel impulse response) between a peer access point (e.g., access point 201) and one or more wireless devices associated with the peer access point. MLME 218 may forward the signal or message requesting the channel measurement to MLME 248 via PHY 228 and PHY 258. SME 246 in access point 201 may accept the signal or message requesting the channel measurement, and may send a channel measurement request to MLME 248 which may in turn measure a channel impulse response between PHY 258 and wireless devices associated with access point 201. SME 246 may receive channel impulse response measurements between PHY 258 and the wireless devices associated with access point 201 from MLME 248 and compile the channel impulse response measurements between PHY 258 and the wireless devices associated with access point 201 and forward the channel impulse response measurements to SME 216 via MLME 248, PHY 258, PHY 228, and MLME 218. The signal or message may correspond to a MAC frame.

Access point 200 may comprise mac layer management entity (MLME) 218 which, may comprise one or more hardware components, firmware that may be executed by a processor that may cause the one or more hardware components to perform certain actions, and/or non-permanent software that may be executed by the processor that may cause the one or more hardware components to send and receive signals or messages from SME 216, UMLME 208, MLME-PLME 220, and/or PLME 222. MLME 218 may comprise one or more application specific integrated circuits (ASICs) to determine channel switch timing information, MAC timing information, channel impulse response measurement protocol information, and channel impulse response measurement frame information. Channel switch timing information may include time in units of microseconds within which MLME 218 may switch from a first channel to a second channel. MAC timing information may include time in units of microseconds referenced from the beginning of a transmission of a first symbol in a frame to a last symbol transmitted in the frame, and/or receipt of a first symbol in a frame to a last symbol received in the frame. Channel impulse response measurement protocol information may comprise steps or procedures that may be used to request and receive channel impulse response measurements from peer access points as described above. Channel impulse response measurement frame information may include a format of a frame that may be used to send and/or receive requests for channel impulse response measurement frame information.

Access point 200 may comprise physical layer management entity (PLME) 222 which, may comprise one or more hardware components, firmware that may be executed by a processor that may cause the one or more hardware components to perform certain actions, and/or non-permanent software that may be executed by the processor that may cause the one or more hardware components to send and receive signals or messages to and from MLME 218 through MPLE-PLME SAP 220. In particular, PLME 222 may perform management of physical layer functions for PHY 218. For instance, when MLME 218 sends a channel impulse response measurement request frame to a peer MLME (e.g., MLME 248) MLME 218 may send at least one service primitive associated with MLME-PLME SAP 220, to PLME 222 which may in turn transmit the channel impulse response measurement request frame to PLME 250 which may in turn forward the channel impulse response measurement request frame to MLME 248 through MLME-PLME SAP 252 using the service primitives associated with MLME-PLME SAP 252. MLME-PLME SAP 252 may comprise an ASIC enabling MLME 218 to send one or more signals or messages (e.g., primitives) to PLME 222, and vice versa, that may enable MLME 218 and PLME 222 to communicate. For example, MLME 218 may correspond to a first ASIC and PLME 222 may correspond to a second ASIC and MLME-PLME SAP 252 may correspond to a third ASIC that may enable MLME 218 and PLME 222 to communicate.

Access point 200 may comprise media access control (MAC) 224 which, may comprise one or more hardware components, firmware that may be executed by a processor that may cause the one or more hardware components to perform certain actions, and/or non-permanent software that may be executed by the processor that may cause the one or more hardware components to send and receive signals or messages to and from PHY 228. In some embodiments, MAC 224 may be referred to the logical link control (LLC) layer. MAC 224 may generate media access control service data units (MSDUs) for transmission to a wireless device. MAC 224 may utilize PHY 228 to transport an MSDU to a peer MAC entity (e.g., a wireless device). The transmission of MSDUs may asynchronous and performed on a connectionless basis. By default, MSDU transport may be on a best-effort basis.

Access point 200 may comprise physical layer (PHY) 228 which, may comprise one or more hardware components, firmware that may be executed by a processor that may cause the one or more hardware components to perform certain actions, and/or non-permanent software that may be executed by the processor that may cause the one or more hardware components to send and receive signals or messages to and from MAC 224. PHY 228 may comprise one or more ASICs that perform a mapping of media access control protocol data units (MPDUs) into a framing format suitable for transmission of user data and management information to wireless devise and reception of user data and management information from wireless devices and one or more ASICs that may define characteristics of, and method of transmitting and receiving data through a wireless mesh comprising two or more wireless stations.

Access point 200 may comprise physical layer service access point (PHY SAP) 226 which, may comprise one or more hardware components, firmware that may be executed by a processor that may cause the one or more hardware components to perform certain actions, and/or non-permanent software that may be executed by the processor that may cause the one or more hardware components to send and receive signals or messages between MAC 224 and PHY 228. For example, PHY SAP 226 may comprise an ASIC enabling MAC 224 to send one or more signals or messages (e.g., primitives) to PHY 228, and vice versa, that may enable MAC 224 and PHY 228 to communicate. For example, MAC 224 may correspond to a first ASIC and PHY 228 may correspond to a second ASIC and PHY SAP 226 may correspond to a third ASIC that may enable MAC 224 and PHY 228 to communicate.

Access point 200 may comprise service access points 222 and 234 which, may comprise one or more hardware components, firmware that may be executed by a processor that may cause the one or more hardware components to perform certain actions, and/or non-permanent software that may be executed by the processor that may cause the one or more hardware components to send and receive signals or messages between access point 200 and access point 201. Service access points 222 and 234 may be wired (e.g., Ethernet ports) logical link control (LLC) service access points (SAPs) through which access points 200 and 201 may communicate. For example, access point 200 may correspond to access point 114 and access point 201 may correspond to access point 110 and SAP 299 may correspond to the connection between wired connections 124 and backhaul network 120, and SAP 234 may correspond to the connection between wired connection 130 and backhaul network 120. In some embodiments, each of SAP 299 and SAP 234 may correspond to traffic in a single direction. In other embodiments, only one of SAP 299 and SAP 234 may be used (e.g., SAP 299) and the other SAP (e.g., SAP 234) may be used if SAP 299 fails or can no longer be used. In other embodiments, both SAP 299 and SAP 234 may be used to send and receive information between access points 200 and 201. In particular, data associated with key management 206 may be transferred between access points 200 and 201 using SAPs 222 and 234. For example, access point 201 may be authenticated by authenticator 204 in access point 200 via SAP 299 and SAP 234.

SAP 262 and SAP 260 may correspond to SAPs on access point 201 and may be similar in function to SAP 299 and SAP 234. SAP 299 may logically be connected to SAP 262 and therefore may provide a LLC connection between UMAC (LA-FST entity) 212 and UMAC (LA-FST entity) 238. In particular, SAP 299 may be a wired ingress point to the internet from access point 200 and SAP 262 may be a wired egress point from the internet and may be used by UMAC (LA-FST entity) 212 to forward data plane frames to access point 260 to be transmitted to a wireless device associated with access points 200 and 201. For example, SAP 299 may correspond to a connection at which wired connection 124 connects to backhaul network 120 and SAP 262 may correspond to a connection at which wired connection 130 connects to access point 110, and UMAC (LA-FST entity) 212 may determine that one or more data plane frames have been received from an application layer that are time sensitive or require a certain Quality of Service (QoS), in which case UMAC (LA-FST entity) 212 may transmit the one or more data plane frames to UMAC (LA-FST entity) 238 out SAP 299 and the one or more data plane frames may be received on SAP 262.

SAP 234 and SAP 260 may be similarly used to connect MBM 202 and MBM 244, to enable management of management plane data frames. For example, a wireless device may send or receive management plane data frames to access point 201 and MBM 244 may forward the management plane data frames to access point 200 through SAPs 260 and 234 to MBM 202 and MBM 202 send a signal or message to the wireless device instructing the wireless device to send and receive data plane frames to access point 200 on the same frequency at which access point 200 (oscillator associated with PHY 218) is operating at.

Access point 201 may comprise upper media access control sublayer management entity (UMLME) 242. UMLME 242 may establish connections between access point 201 and a UMLME, for example UMLME 268, in a wireless device such as wireless device 203. UMLME 242 may comprise one or more hardware components, firmware that may be executed by a processor that may cause the one or more hardware components to perform certain actions, and/or non-permanent software that may be executed by the processor that may cause the one or more hardware components to generate or receive media access control (MAC) frames from wireless devices. The MAC frames that UMLME 242 may produce may be frames associated with registering wireless devices. The frames associated with registering wireless devices (registration frames) may be transmitted quasi-periodically by access point 200 in order to establish a timing synchronization function (TSF). The registration frames may include fields comprising a basic service set identification (BSS-ID), timestamp (for synchronization), traffic indication map to indicate when a wireless station should enter into low power mode if traffic is data is not available for it, and a field for roaming data. The registration frames may be transmitted as beacon frames to the wireless devices which may in turn measure the received signal strength (RSS) associated with the received beacon frames.

UMLME 242 may also associate and/or disassociate wireless devices that attempt to connect and disconnect to access point 201 as the wireless devices roam from a BSS not associated with access point 201 to a BSS associated with access point 201. UMLME 242 may broadcast at least one handoff beacon frame periodically to the wireless stations and the strongest beacon may be detected by the wireless devices. The handoff beacon frame may comprise fields including a timestamp, beacon interval, capabilities of access point 201, extended service set (ESS) ID, and traffic indication map (TIM). UMLME 242 may receive probe requests from the wireless devices and may send probe responses to the wireless devices in return, comprising the same information in the handoff beacon frame excluding the TIM. UMLME 242 may then receive a re-association request comprising information about the wireless devices and information about another UMLME associated with another access point that the wireless devices are being handed over from.

Access point 201 may comprise a media access control-service access point (MAC-SAP) 236 which may comprise one or more hardware components, firmware that may be executed by a processor that may cause the one or more hardware components to perform certain actions, and/or non-permanent software that may be executed by the processor that may cause the one or more hardware components to send and receive signals between UMLME 242 and upper media access control (UMAC) (LA-fast session transfer FST entity) 238 corresponding to messages associated with fast session transfers of connections from second radio (e.g., PHY 258) to first radio (e.g., PHY 228). A session associated with a fast session transfer may comprise state information stored in a second memory associated with second radio (e.g., PHY 258) and a first memory associated with first radio (e.g., PHY 228). Second radio (e.g., PHY 258) may communicate with first radio (e.g., PHY 228) via MBM 242. The state information may be stored in the first memory and the second memory before and after the fast session transfer. The state information may comprise block acknowledgement agreement messages, traffic stream (TS) information corresponding to data streams associated with the first and second radios, association state information, robust security network association (RSNA) information, security keys, sequence counter information, and packet number (PN) information, associated with first radio (e.g., PHY 228) and second radio (e.g., PHY 258).

Access point 201 may comprise media access control (MAC) service access point (SAP) 236 which, may comprise one or more hardware components, firmware that may be executed by a processor that may cause the one or more hardware components to perform certain actions, and/or non-permanent software that may be executed by the processor that may cause the one or more hardware components to send and receive signals or messages to UMAC licensed access/link aggregation-fast session transfer (LA-FST) entity UMAC (LA-FST entity) 238. For example, MAC-SAP 236 may receive MAC frames associated with the data plane, and may transmit the MAC frames to a wireless device via PHY 258. In particular, traffic steering 214 may receive MAC frames, associated with the data plane, from a processor executing applications, and may steer the MAC frames to PHY 258 by transmitting a message or signal to UMAC (LA-FST entity) 238, via SAPs 222 and 262, which will in turn transmit a message or signal to MAC 254 indicating that a signal corresponding to the MAC frames should be transmitted on PHY 258 using one or more service primitives associated with PHY SAP 256.

Access point 201 may comprise media access control (MAC) service access point UMAC (LA-FST entity) 238 which, may comprise one or more hardware components, firmware that may be executed by a processor that may cause the one or more hardware components to perform certain actions, and/or non-permanent software that may be executed by the processor that may cause the one or more hardware components to send and receive signals or messages to UMAC (LA-FST entity) 238. UMAC (LA-FST entity) 238 may store MAC or logic link layer state information (non-physical layer state information) associated with access point 201 and access point 201, and the information shared between access point 200 and access point 201. This information may be referred to session information. In particular, UMAC (LA-FST entity) 238 may receive a request to transfer a session from access point 200 to access point 201 where access point 200 operates at first frequency and access point 201 operates at a second frequency. For example, there may be a first oscillator in physical layer (PHY) 228 of access point 200 that may oscillate at a frequency of 5 GHZ, and there may be a second oscillator in physical layer (PHY) 258 of access point 201 that may oscillate at a frequency of 60 GHz, and UMAC (LA-FST entity) 212 may determine which physical layer to transfer the session to. In some embodiments, UMAC (LA-FST entity) 238 may receive messages or signals from UMAC (LA-FST entity) 212 to transfer data associated with the data plane to PHY 258.

Access point 201 may comprise service access point station management entity (SME) 246 which, may comprise one or more hardware components, firmware that may be executed by a processor that may cause the one or more hardware components to perform certain actions, and/or non-permanent software that may be executed by the processor that may cause the one or more hardware components to send and receive signals or messages from PHY 258, as well as any changes in an operating channel, (e.g., using information obtained from out-of-band communication over-the-air frame exchanges). SME 246 is a cross-layer entity that may internally communicate with multiple layers. For example, SME 246 may communicate with MLME 248 and PLME 250 through a service access point (SAP) not shown. In some embodiments, SME 246 may have an interface application layer as well. SME 246 monitors and controls the operation of access point 201. An operator of access point 201 may control the operation of the device (e.g., specifying a SSID, BSSID, channel numbers, security keys, change the status of the device, adjust the received signal strength (RSS) threshold etc.) by issuing a series of commands, and SME 246 will send and/or receive signals or message to and/or from MLME 248 and PLME 250 in order to execute the commands.

Access point 201 may comprise station management entity (SME) 246 which, may comprise one or more hardware components, firmware that may be executed by a processor that may cause the one or more hardware components to perform certain actions, and/or non-permanent software that may be executed by the processor that may cause the one or more hardware components to send and receive signals or messages from entities (e.g., MBM, 244, authenticator 204, key management 206, UMLME 208, MAC SAP 210, UMAC (LA-FST entity) 212, traffic steering 214, mac layer management entity (MLME) 218, mac layer management entity (MLME)-physical layer management entity (PLME) service access point (SAP) 220, physical layer management entity (PLME) 222, media access control (MAC) 224, physical layer (PHY) service access point (SAP) 226, and/or physical layer (PHY) 228). SME 246 may determine PHY 258 parameters, as well as any changes in the operating channel, for example, using information obtained via out-of-band communication or over-the-air frame exchange.

SME 246 may determine certain measurements associated with a channel on PHY 258, and may determine whether to switch PHY 258 to a different channel. For example, SME 246 may cause to send a signal or message to MLME 248 requesting a channel measurement (e.g., channel impulse response) between access point 201 and one or more wireless devices associated with access point 201. MLME 248 may receive a signal or message from MLME 218 requesting the channel measurement via PHY 228 and PHY 258. SME 246 in access point 201 may accept the signal or message requesting the channel measurement, and may send a channel measurement request to MLME 248 which may in turn measure a channel impulse response between PHY 258 and wireless devices associated with access point 201. SME 246 may receive channel impulse response measurements between PHY 258 and the wireless devices associated with access point 201 from MLME 248 and compile the channel impulse response measurements between PHY 258 and the wireless devices associated with access point 201 and forward the channel impulse response measurements to SME 216 via MLME 248, PHY 258, PHY 228, and MLME 218. The signal or message may correspond to a MAC frame.

Access point 201 may comprise mac layer management entity (MLME) 248 which, may comprise one or more hardware components, firmware that may be executed by a processor that may cause the one or more hardware components to perform certain actions, and/or non-permanent software that may be executed by the processor that may cause the one or more hardware components to send and receive signals or messages from SME 246, UMLME 242, MLME-PLME 252, and/or PLME 250. MLME 248 may comprise one or more application specific integrated circuits (ASICs) to determine channel switch timing information, MAC timing information, channel impulse response measurement protocol information, and channel impulse response measurement frame information. Channel switch timing information may include time in units of microseconds within which MLME 248 may switch from a first channel to a second channel. MAC timing information may include time in units of microseconds referenced from the beginning of a transmission of a first symbol in a frame to a last symbol transmitted in the frame, and/or receipt of a first symbol in a frame to a last symbol received in the frame. Channel impulse response measurement protocol information may comprise steps or procedures that may be used to request and receive channel impulse response measurements from peer access points as described above. Channel impulse response measurement frame information may include a format of a frame that may be used to send and/or receive requests for channel impulse response measurement frame information.

Access point 201 may comprise physical layer management entity (PLME) 250 which, may comprise one or more hardware components, firmware that may be executed by a processor that may cause the one or more hardware components to perform certain actions, and/or non-permanent software that may be executed by the processor that may cause the one or more hardware components to send and receive signals or messages to and from MLME 248 through MPLE-PLME SAP 252. In particular, PLME 250 may perform management of physical layer functions for PHY 248. For instance, when MLME 218 sends a channel impulse response measurement request frame to a peer MLME (e.g., MLME 248) MLME 218 may send at least one service primitive associated with MLME-PLME SAP 220, to PLME 222 which may in turn transmit the channel impulse response measurement request frame to PLME 250 which may in turn forward the channel impulse response measurement request frame to MLME 248 through MLME-PLME SAP 252 using the service primitives associated with MLME-PLME SAP 252. MLME-PLME SAP 252 may comprise an ASIC enabling MLME 248 to send one or more signals or messages (e.g., primitives) to PLME 222, and vice versa, that may enable MLME 218 and PLME 222 to communicate. For example, MLME 218 may correspond to a first ASIC and PLME 222 may correspond to a second ASIC and MLME-PLME SAP 252 may correspond to a third ASIC that may enable MLME 218 and PLME 222 to communicate.

Access point 201 may comprise media access control (MAC) 254 which, may comprise one or more hardware components, firmware that may be executed by a processor that may cause the one or more hardware components to perform certain actions, and/or non-permanent software that may be executed by the processor that may cause the one or more hardware components to send and receive signals or messages to and from PHY 258. In some embodiments, MAC 254 may be referred to the logical link control (LLC) layer. MAC 254 may generate media access control service data units (MSDUs) for transmission to a wireless device. MAC 254 may utilize PHY 258 to transport an MSDU to a peer MAC entity (e.g., a wireless device). The transmission of MSDUs may asynchronous and performed on a connectionless basis. By default, MSDU transport may be on a best-effort basis.

Access point 201 may comprise physical layer (PHY) 258 which, may comprise one or more hardware components, firmware that may be executed by a processor that may cause the one or more hardware components to perform certain actions, and/or non-permanent software that may be executed by the processor that may cause the one or more hardware components to send and receive signals or messages to and from MAC 254. PHY 258 may comprise one or more ASICs that perform a mapping of media access control protocol data units (MPDUs) into a framing format suitable for transmission of user data and management information to wireless devise and reception of user data and management information from wireless devices and one or more ASICs that may define characteristics of, and method of transmitting and receiving data through a wireless mesh comprising two or more wireless stations.

Access point 201 may comprise physical layer service access point (PHY SAP) 256 which, may comprise one or more hardware components, firmware that may be executed by a processor that may cause the one or more hardware components to perform certain actions, and/or non-permanent software that may be executed by the processor that may cause the one or more hardware components to send and receive signals or messages between MAC 254 and PHY 258. For example, PHY SAP 526 may comprise an ASIC enabling MAC 254 to send one or more signals or messages (e.g., primitives) to PHY 258, and vice versa, that may enable MAC 254 and PHY 258 to communicate. For example, MAC 254 may correspond to a first ASIC and PHY 258 may correspond to a second ASIC and PHY SAP 256 may correspond to a third ASIC that may enable MAC 254 and PHY 258 to communicate.

FIG. 2B depicts an illustrative logical connection between two wireless radios of a wireless device 203, which may be an example of the device 114 in FIG. 1, according to one or more example embodiments of the disclosure. Wireless device 203 may comprise one or more hardware components, firmware that may be executed by a processor that may cause the one or more hardware components to perform certain actions, and/or non-permanent software that may be executed by the processor that may cause the one or more hardware components to perform certain actions consistent with the disclosure herein or modifications to the actions consistent with the disclosure herein. Wireless device 203 may be referred to as a multi-band capable device. Wireless device 203 may comprise a first wireless station (STA 265) and a second wireless station (STA 267). STA 265 may comprise station management entity (SME) 296, physical layer management entity (PLME) 292, media access control layer management entity physical layer management entity service access point (MLME-PLME SAP) 282, media access control layer management entity (MLME) 288, physical layer (PHY) 284, physical layer service access point (PHY SAP) 295, media access control (MAC) 276. STA 267 may comprise station management entity (SME) 298, physical layer management entity (PLME) 294, media access control layer management entity physical layer management entity service access point (MLME-PLME SAP) 297, media access control layer management entity (MLME) 290, physical layer (PHY) 286, physical layer service access point (PHY SAP) 282, and media access control (MAC) 278. These components of wireless device 203 may be similar in functionality and design to those in access points 200 and 201, as described above.

Wireless device 203 may further comprise upper media access control (link aggregation-fast session transfer entity) (UMAC (LA-FST entity) 274, traffic steering 270, media access control service access point (MAC SAP) 272, upper media access control layer management entity (UMLME) 268, multi-band management entity (MBM) 262, supplicant 264, and key management 266. These components of wireless device 203 may be similar in function and design to those in access points 200 and 201, as described above.

Multi-Band Management (MBM) entity 262 may be responsible for setting up, configuring, removing, or transferring fast session transfer (FST) sessions established on a first band/channel associated with first radio (e.g., PHY 284) to a second band/channel associated with a second radio (e.g., PHY 286). MBM entity 262 may be implemented in an application specific integrated circuit (ASIC), may coincide with one or more instructions executed by a processor, or may be a software defined radio (SDR) chipset.

Wireless device 203 may comprise supplicant 264 which may comprise one or more hardware components, firmware that may be executed by a processor that may cause the one or more hardware components to perform certain actions, and/or non-permanent software that may be executed by the processor that may cause the one or more hardware components to be authenticated by authenticator 204 of AP 200. Supplicant 264 may receive EAP-request Identify frames, and then may transmit an EAP-response Identity frame comprising an identifier associated with supplicant 264 such as a user ID to authenticator 204. Authenticator 204 may then encapsulate an EAP-response Identity frame in an authentication, authorization, and accounting (AAA) Access Request packet and may forward the encapsulated EAP-response Identity frame to an AAA server. In some embodiments, the AAA server may be a remote authentication dial-in user service (RADIUS) server. In some embodiments, supplicant 264 may also initiate or restart authentication by transmitting an EAPOL-Start frame to authenticator 204, which may reply with an EAP-Request Identity frame. After authenticator 204 transmits the encapsulated EAP-response Identity frame to the AAA server, authenticator 204 may receive an EAP Request frame encapsulated in an AAA access challenge packet from AAA server, and the EAP Request may include the EAP method used by the AAA server to authenticate supplicant 264. This may be referred to as an initiation of the authentication of the supplicant. In some embodiments, the EAP method may include EAP-MD5, EAP-POTP, EAP-GTC, EAP-TLS, EAP-IKEv2, EAP-SIM, EAP-AKA and EAP-AKA′. In other embodiments, the EAP method may include EAP-TLS, EAP-SIM, EAP-AKA, LEAP and EAP-TTLS. Yet still in other embodiments, vendor specific EAP methods may be used for the EAP method.

Authenticator 204 may encapsulate the EAP request in an EAPOL frame and transmit it to supplicant 264. After the supplicant 264 receives the EAP request supplicant 264 may start using the EAP method indicated in the EAP request. In some embodiments, supplicant 264 may transmit an EAP frame in an EAPOL frame to authenticator 204 which may in turn transmit the EAP frame to the AAA server in an AAA packet, wherein the EAP frame includes a negative acknowledgment (NAK) indicating the EAP methods that supplicant 264 wants to perform. In some embodiments, a first supplicant may perform a first EAP method, and a second supplicant may perform a second EAP method. This may be referred to as the negotiation of the authentication method used to authenticate the supplicant.

After supplicant 264 and the AAA server agree on an EAP method, supplicant 264 may transmit EAP requests to the AAA server, in EAPOL frames and authenticator 204 may extract the EAP requests and encapsulate the EAP requests in AAA Request packets and transmit the EAP requests to the AAA server. Authenticator 204 may then receive AAA Response packets, from the AAA server comprising a EAP success message, which may in turn be encapsulated in an EAPOL frame and transmitted to supplicant 264. The EAP success message may indicate that the supplicant has been authenticated. After the EAP success message is received, authenticator 204 may open the controlled port to supplicant 264 so that data can be sent between the supplicant and the AAA server or other (first) supplicants that have been authenticated by the AAA server to communicate with supplicant 264.

Key management 266 may comprise one or more hardware components, firmware that may be executed by a processor that may cause the one or more hardware components to perform certain actions, and/or non-permanent software that may be executed by the processor that may cause the one or more hardware components to send and receive signals or messages to supplicant 264. Key management 266 may be implemented using a 4-Way Handshake, Group Key Handshake, and PeerKey Handshake as defined in IEEE 802.11 with access points or wireless stations. For example, a 4-Way Handshake or Group Key Handshake may be implemented between authenticator 204 of the AP 200 and supplicant 264 using one or more keys stored or generated in key management 206.

Wireless device 203 may comprise upper media access control sublayer management entity (UMLME) 268. UMLME 268 may establish connections between wireless device 203 and a UMLME, for example UMLME 208, in an access point such as access point 200. UMLME 268 may comprise one or more hardware components, firmware that may be executed by a processor that may cause the one or more hardware components to perform certain actions, and/or non-permanent software that may be executed by the processor that may cause the one or more hardware components to generate or receive media access control (MAC) frames from wireless devices. The MAC frames that UMLME 268 may produce may be frames associated with registering wireless devices. The frames associated with registering wireless devices (registration frames) may be transmitted quasi-periodically by wireless device 203 in order to establish a timing synchronization function (TSF). The registration frames may include fields comprising a basic service set identification (BSS-ID), timestamp (for synchronization), traffic indication map to indicate when a wireless station should enter into low power mode if traffic is data is not available for it, and a field for roaming data. The registration frames may be transmitted as beacon frames to the wireless devices which may in turn measure the received signal strength (RSS) associated with the received beacon frames.

Wireless device 203 may comprise UMAC (LA-FST entity) 274 which, may comprise one or more hardware components, firmware that may be executed by a processor that may cause the one or more hardware components to perform certain actions, and/or non-permanent software that may be executed by the processor that may cause the one or more hardware components to send and receive signals or messages between media access control service access point (MAC SAP) 272 and Traffic Steering 274. UMAC (LA-FST entity) 274 may store MAC or logic link layer state information (non-physical layer state information) about STA 265 and STA 267, and the information shared between STA 265 and STA 267. This information may be referred to session information. In particular, UMAC (LA-FST entity) 274 may transfer a session from STA 265 to STA 267 where STA 265 operates at first frequency and STA 267 operates at a second frequency. For example, there may be a first oscillator in physical layer (PHY) 284 may oscillate at a frequency of 5 GHz, and there may be a second oscillator in physical layer (PHY) 286 that may oscillate at a frequency of 60 GHz, and UMAC (LA-FST entity) 274 may determine which physical layer to transfer the session to. In some embodiments UMAC (LA-FST entity) 274 may receive messages or signals from Traffic Steering 270 to transfer data associated with the data plane to PHY 284 and may receive messages or signal from Traffic Steering 270 to transfer data associated with the management plane to PHY 286.

Wireless device 203 may comprise media access control service access point (MAC SAP) 272 which, may comprise one or more hardware components, firmware that may be executed by a processor that may cause the one or more hardware components to perform certain actions, and/or non-permanent software that may be executed by the processor that may cause the one or more hardware components to send and receive signals or messages between UMLME 268 and UMAC (LA-FST entity) 274. MAC SAP 272 may comprise an ASIC enabling UMLME 268 to send one or more signals or messages (e.g., primitives) to UMAC (LA-FST entity) 274, and vice versa, that may enable UMLME 268 and UMAC (LA-FST entity) 274 to communicate. For example, UMLME 268 may correspond to a first ASIC and UMAC (LA-FST entity) 274 may correspond to a second ASIC and MAC SAP 272 may correspond to a third ASIC that may enable UMLME 268 and UMAC (LA-FST entity) 274 to communicate.

Wireless device 203 may comprise traffic steering 270 which, may comprise one or more hardware components, firmware that may be executed by a processor that may cause the one or more hardware components to perform certain actions, and/or non-permanent software that may be executed by the processor that may cause the one or more hardware components to send and receive signals or messages from UMAC (LA-FST entity) 274. Traffic steering 270 may control data associated with the management plane. In particular, traffic steering 270 may determine whether management plane frames should be transmitted via PHY 284 or PHY 286. In some embodiments, traffic steering 270 may determine that management plane frames should be transmitted via PHY 284 associated with an oscillator oscillating at a lower frequency (e.g., 5 GHZ).

The components of STA 265 (e.g., SME 296, PLME 292, MLME-PLME SAP 282, MLME 288, MAC 276, PHY SAP 295, and PHY 284) may be similar in functionality and design to those of the components of access point 200 (e.g., SME 216, PLME 222, MLME-PLME SAP 220, MLME 218, MAC 224, PHY SAP 226, and PHY 228) and the components of STA 267 (e.g., SME 298, PLME 294, MLME-PLME SAP 297, MLME 290, MAC 278, PHY SAP 282, and PHY 286) may be similar in functionality and design to those of the components of access point 200 (e.g., SME 246, PLME 250, MLME-PLME SAP 252, MLME 248, MAC 254, PHY SAP 256, and PHY 258). In some embodiments, the hardware used to implement the components in access points 200 and 201 and wireless device 203 may be exactly the same. For example, wireless device 203 may serve as an access point and supplicant 264 may implement the same functionality as authenticator 204 and therefore can be used as an access point such as access point 200.

In an illustrative example, embodiments of the present disclosure may enable a wireless device, such as a smartphone, laptop, tablet, or wearable device, that needs to aggregate data plane and management plane links, to efficiently transmit and receive data between multiple radios in a wireless device, wherein each radio communicates either management plane data on a management plane link to a first access point or data plane data on a data plane link to a second access point. For example, there may be an access point operating at 5 GHz (e.g., access point 104), which may be indicated by AP 303 in FIG. 3, that may be used to transmit and receive management plane data, and multiple access points operating at 60 GHz (e.g., access points 102, 106, 110, and 108) on which data plane data may be transmitted. There may be a wireless device (e.g., user device 114) that may comprise a first wireless radio (e.g., STA 265) operating at 5 GHz and a second wireless radio (e.g., STA 267) operating at 60 GHz. The wireless device, and in particular STA 265, which may be indicated by STA 301 in FIG. 3, may associate with AP 303 and perform full association, association frame exchanges, IEEE 802.1x authentication, and a 4-way handshake as illustrated in FIG. 3. STA 301 and AP 303 may exchange multi-band capabilities and initiate a multi-band aggregation setup protocol to establish a multi-band aggregation session. In the setup protocol, STA 301 and AP 303 may negotiate a secondary AP (e.g., access point 106) that may be used by the wireless device for data plane transfer, on which link the management plane data will be transferred to AP 303, and the parameters for single association and single security across bands. After the setup protocol is completed, the data plane can be transferred from access point 104 to access point 106, and then BSS transition of access point 106 may be accomplished based at least in part on management plane data on access point 104. In some embodiments, transferring the data plane, and more particularly data plane data, to access point 106, may increase the throughput of STA 301 because STA 301 may be used exclusively to transmit and receive data plane data instead of having to transmit data plane data and management plane data, as would be the case with a wireless device with just one wireless radio.

FIG. 3 depicts an illustrative authentication timing diagram, according to one or more example embodiments of the disclosure. Timing sequence 300 may comprise an exchange of a sequence of messages between a station in a wireless device, wherein the wireless device may comprise at least one station, and a server that the station may be attempting to authenticate itself with via an access point. The access point may be referred to as an anchor or master access point because it may be the access point that the station, associates with first if there are two or more stations in the wireless device. The server may be an authentication, authorization, and accounting (AAA) server, and may implement the functions described above.

STA 301 may be a first station in a wireless device (not shown), operating at a fist frequency, AP 303 may be an anchor operating at the first frequency, and server 305 may be an AAA server. AP 303 may transmit beacon 302 to STA 301 comprising information that may be used by STA 301 to associate with AP 303. Beacon 302 may be a frame transmitted in an infrastructure basic service set (IBSS), and may comprise a timestamp filed indicating when beacon 302 is transmitted, a beacon interval field indicating the interval in time between the transmission of beacons, a capability information filed indicating whether the network STA 301 is attempting to associate with is an ad hoc network or infrastructure network, polling information, and encryption methods that AP 303 uses to encrypt messages. Polling information may include data about the method used by AP 303 to poll stations associated with a basic service set (BSS) associated with AP 303. Beacon 302 may also comprise a field indicating a service set identification (SSID), data rates supported by AP 303, frequency-hopping parameters, direct-sequence parameters, contention-free parameters, independent basic service set parameters, and a traffic indication map (TIM). STA 301 may transmit probe request 304 frame to AP 303. AP 303 may transmit probe response 306 frame to STA 301. STA 301 may transmit association request 308 frame to AP 303. AP 303 may transmit association response 310 frame to STA 301. STA 301 may transmit authentication 312 frame to server 305. STA 301 and AP 303 may perform handshake 314 (e.g., a 4-way handshake) and then may exchange protected traffic 316, wherein protected traffic 316 may be management plane data. The process of transmitting association request 308 frame, association response 310 frame, and authentication 312 frame is explained herein, for example, with reference to authenticator 204 and supplicant 264. For example, STA 301 may comprise supplicant 264, AP 303 may comprise authenticator 204, and server 305 may correspond to AAA server.

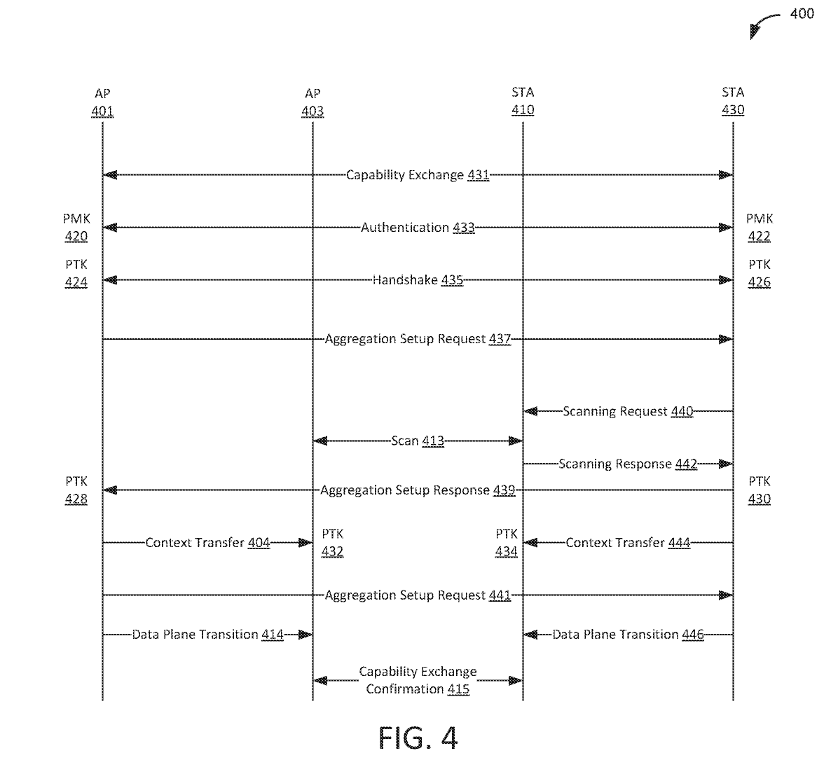

With reference to FIG. 4, illustrated is a timing diagram of messages for the enablement of protected traffic exchange between a secondary AP (e.g., AP 403) and a secondary STA (e.g., STA 410) following the establishment of multi-band aggregation. That is, illustrated is an example of a data plane connection and management plane connection transfer, according to one or more example embodiments of the disclosure. By way of an example, a first wireless radio, in a wireless device (e.g., wireless device 203) operating at 5 GHz (STA 430) may be associating with AP 401 operating at 5 GHz, wherein STA 430 and AP 401 perform the IEEE 802.1x authentication and 4-way handshake, as illustrated above. After the association, then STA 430 and AP 401 may then initiate multiband aggregation setup, wherein AP 401 may recommend an AP (e.g., AP 403), operating at 60 GHz, to which a second wireless radio in the wireless device (e.g., wireless device 203) operating at 60 GHz (e.g., STA 410) may connect to. The recommendation may be based on scans and/or a received signal strength indicator (RSSI) threshold above which aggregation may be possible. STA 410 may then perform scan and/or RSSI measurements associated with AP 403. After a STA 410 determines that AP 403 is a target AP, STA 410 may report to STA 430 that AP 403 is the target AP over which data plane management data should be transferred. After this information is relayed from STA 430 to STA 410 the interfaces of STA 410 and AP 403 are considered secured and security keys such as pairwise transient keys (PTKs) may be used to exchange data plane data between STA 410 and AP 403. When AP 401 triggers transition of data plane data to AP 403, a secured connection between AP 403 and STA 430 exists and data plane data may be exchanged between AP 403 and STA 430 without the need for a 4-way handshake and without necessarily sending probe, authentication, association request, and responses. As an example, AP 401 may be similar to AP 104, AP 403 may be similar to anyone of APs 102, 106, 108, or 110, and STAs 410 and 430 may be wireless radios include in user device 114.

With reference to FIG. 4, the timing sequence 400 may comprise an exchange of messages between at least two access points and two radios (stations) within a wireless device. In particular, AP 401 and STA 430 may exchange capability exchange 431 frames, and then may exchange authentication 433 frames. In some embodiments, authentication 433 frames may comprise extensible authentication protocol (EAP) frames such as the ones described above. For example, AP 401 and STA 430 may exchange the same, or similar messages, to those exchanged between STA 301 and AP 303. AP 401 and STA 430 may determine pairwise master key (PMK) 420 and pairwise master key (PMK) 422 independently, wherein PMK 420 and PMK 422 may be based on (EAP) parameters included in the EAP frames. PMK 420 and PMK 422 may be identical. AP 401 and STA 430 may perform handshake 435, and then derive pairwise transient key (PTK) 424 and pairwise transient key (PTK) 426 respectively. After AP 401 and STA 430 derive PTK 424 and PTK 426 AP 401 and STA 430 may exchange protected traffic data which may comprise data plane data.

Next, AP 401 may transmit multiband aggregation setup request 437 frame to STA 430. STA 430 may transmit scanning request 440 frame to STA 410. AP 403 and STA 410 may exchange scan 413 frames. For example, STA 410 may comprise elements of STA 267, in particular MLME 290 of STA 267, and MLME 290 may comprise one or more service primitives that may cause MLMM-PLME SAP 297 to send one or more signals to PLME 294 that may in turn cause PLME 294 to transmit one or more signals to PLME 250 of AP 201 which may correspond to AP 403. PLME 250 may in turn forward a signal comprising the service primitives to MLME-PLME SAP 252 which may in turn communicate the service primitives to MLME 248. STA 410 may then transmit scanning request 442 frame to STA 430. In particular, MLME 248 may comprise one or more primitives that may cause MLME 290 to transmit the scanning request frame to MLME 248. STA 430 may transmit aggregation setup response 439 to AP 401 and then pairwise transient key (PTK) 430 and pairwise transient key (PTK) 428 may be generated by STA 430 and AP 401 respectively. STA 430 may transmit context transfer 444 frame to STA 410, and context transfer 444 frame may comprise PTK 430 and may be indicated as PTK 434 upon receipt of PTK 430. For example, STA 430 may be a part of a wireless device such as wireless device 203 comprising a supplicant such as supplicant 264 that may receive keys derived by key management 266. Context transfer 444 may be transferred in response to one or more primitives in UMAC (LA-FST entity) and/or Traffic Steering 270. PTK 434 is the same as PTK 430.

AP 401 may transmit context transfer 404 frame to AP 403, and context transfer 404 frame may comprise PTK 428 and may be indicated as PTK 432 upon receipt of PTK 428. For example, AP 401 may be AP 200 and MLME 218 in AP 200 may transmit context transfer 404 frame to MLME 248 in AP 201, which may be AP 403. MLME 218 may transmit context transfer 404 frame via SAP 222. In other words, PTK 432 is the same as PTK 428. AP 401 may transmit aggregation setup request 441 frame to STA 430, then AP 401 and STA 430 may transmit data plane transition frames 414 and 446 to AP 403 and STA 410 respectively. For example, AP 401 may be AP 200 and AP 403 may be AP 201, STA 410 may be STA 267, and STA 430 may be STA 265. UMAC (LA-FST entity) 212, in AP 200, may transmit data plane transition frames 414 to UMAC (LA-FST entity) 238 via SAPs 222 and 262 respectively, and MLME 288 in STA 265 may transmit data plane transition frames 446 to MLME 290 in STA 267. AP 403 and STA 410 may then exchange capability exchange confirmation 415 frames. For example, a component like MLME 248 and MLME 290 in AP 403 and STA 410 respectively, may exchange capability exchange confirmation 415 frames, wherein capability exchange confirmation 415 frames may comprise operational capabilities of AP 403 and STA 410. For instance, capability exchange confirmation 415 may comprise information about extended service sets (ESSs) that AP 403 belongs to, independent basic service sets (IBSSs) that AP 403 belongs to, and/or spectrum management data associated with MLME 248.

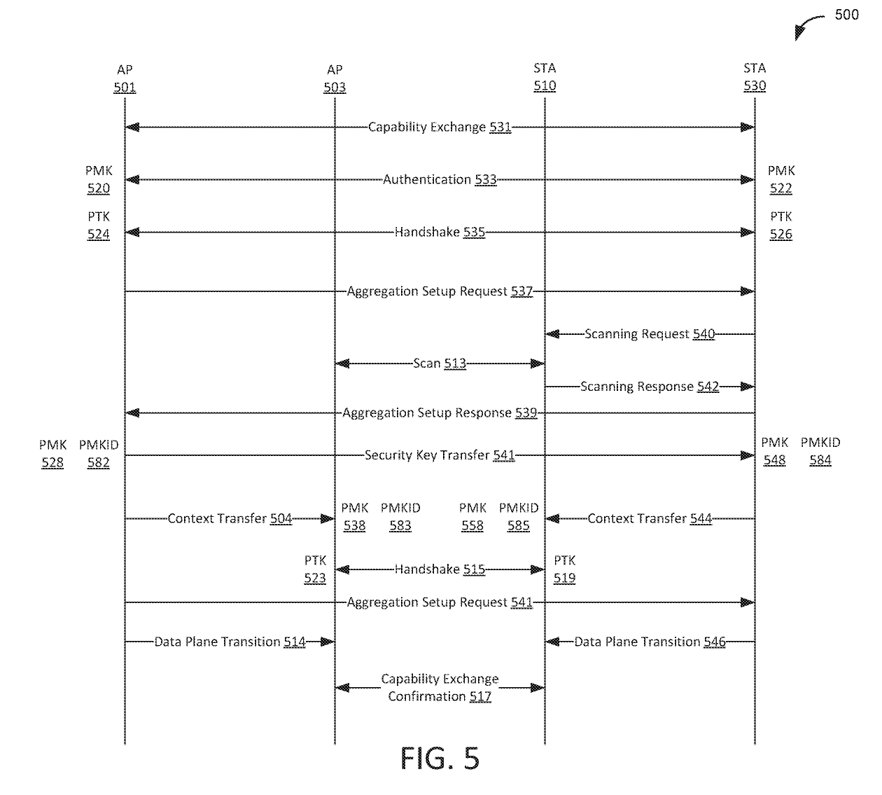

FIG. 5 may be an embodiment of FIG. 4. In FIG. 5 what is illustrated is a first wireless radio, in a wireless device (e.g., wireless device 203) operating at 5 GHz (STA 530) associating with AP 501 operating at 5 GHz wherein STA 530 and AP 501 perform the IEEE 802.1x authentication and 4-way handshake as illustrated above. After the association STA 530 and AP 501 may then initiate multiband aggregation setup, wherein AP 501 may recommend an AP (e.g., AP 503), operating at 60 GHz, to which a second wireless radio in the wireless device (e.g., wireless device 203) operating at 60 GHz (e.g., STA 510) may connect to. The recommendation may be based on scans and/or a received signal strength indicator (RSSI) threshold above which aggregation may be possible. STA 510 may then perform scan and/or RSSI measurements associated with AP 503. After a STA 510 determines that AP 503 is a target AP, STA 510 may report to STA 530 that AP 503 is the target AP over which data plane management data should be transferred. After this if a nonce, MAC address or SSID of the target AP is not known, it may be transmitted, by STA 530 to AP 501. Based on this STA 530 may derive a pairwise management key (PMK) and transfer it to STA 510. The PMK may be transferred to indicate to STA 510 that data plane data will be transferred data associated with wireless device 203 to AP 503. Simultaneously, AP 501 may transfer the PMK to AP 503. With this option, the interfaces between STA 510 and AP 503 may not be fully secured, but the traffic transferred between STA 510 and AP 503 may be secured or protected using the PMK by transferring the PMK between STA 510 and AP 503.

FIG. 5 depicts an illustrative data plane connection and management plane connection transfer timing diagram, according to one or more example embodiments of the disclosure. Timing sequence 500 may comprise an exchange of messages between at least two access points and two radios (stations) within a wireless device. In particular, AP 501 and STA 530 may exchange capability exchange 531 frames, and then may exchange authentication 533 frames. For instance, AP 501 may comprise one or more components in AP 200 and STA 530 may comprise one or more components in STA 265. For example, a component like MLME 248 and MLME 288 in AP 501 and may exchange capability exchange confirmation 531 frames, wherein capability exchange confirmation 531 frames may comprise operational capabilities of AP 403 and STA 410. For instance, capability exchange confirmation 415 may comprise information about extended service sets (ESSs) that AP 403 belongs to, independent basic service sets (IBSSs) that AP 403 belongs to, and/or spectrum management data associated with MLME 248.

In some embodiments, authentication 533 frames may comprise extensible authentication protocol (EAP) frames such as the ones described above. For example, AP 401 and STA 430 may exchange the same or similar messages, to those exchanged between STA 301 and AP 303. AP 501 and STA 530 may determine pairwise master key (PMK) 520 and pairwise master key (PMK) 522 independently, wherein PMK 520 and PMK 522 may be based on (EAP) parameters included in the EAP frames. PMK 520 and PMK 522 may be identical. AP 501 and STA 530 may perform handshake 535, and then derive pairwise transient key (PTK) 524 and pairwise transient key (PTK) 526 respectively. AP 501 may transmit aggregation setup request 537 frame to STA 530. STA 530 may transmit scanning request 540 frame to STA 510. AP 503 and STA 510 may exchange scan 513 frames. For example, AP 503 may comprise components such as MLME 248 and STA 510 may comprise components such as MLME 248, and in particular MLME 290 may comprise one or more primitives that may cause MLME 290 to transmit the scanning request frame to MLME 248. STA 510 may then transmit scanning request 542 frame to STA 530. STA 530 may transmit aggregation setup response 539 to AP 501. PMK 528 may be indicated as PMK 538 upon receipt of PMK 528, and PMK 548 may be indicated as PMK 558 upon receipt of PMK 548. For example, STA 530 may be a part of a wireless device such as wireless device 203 comprising a supplicant such as supplicant 264 that may receive keys derived by key management 266. Context transfer 544 may be transferred in response to one or more primitives in UMAC (LA-FST entity) and/or Traffic Steering 270. In other words, PMK 538 is the same as PMK 528 and PMK 558 is the same as PMK 548. In some embodiments, STA 530 may not transmit PMK 548 to STA 510, and may instead transmit one or more encryption parameters, for example a nonce and PMK 522, in context transfer 544, to STA 510 and STA 510 may derive PMK 558. AP 501 may transfer security key transfer 541 frame to STA 530. In some embodiments. AP 501 and STA 530 may generate pairwise master key (PMK) 528 and pairwise master key (PMK) 548 respectively, and my transmit context transfer 504 frame comprising PMK 528 to AP 503 and context transfer 544 comprising PMK 548 to STA 510 respectively. AP 503 and STA 510 may generate pairwise master key identification (PMKID) 583 and pairwise master key identification (PMKID) 585. AP 503 and STA 510 may perform handshake 515, and then derive pairwise transient key (PTK) 523 and pairwise transient key (PTK) 519 respectively. AP 501 may transmit aggregation setup request 541 frame to STA 530, then AP 501 and STA 530 may transmit data plane transition frames 514 and 546 to AP 503 and STA 510 respectively. For example, AP 501 may comprise elements of AP 200 and AP 503 may comprise elements of AP 201, STA 510 may comprise elements of STA 267, and STA 530 may comprise elements of STA 265. For instance, UMAC (LA-FST entity) 212, in AP 200, may transmit data plane transition frames 414 to UMAC (LA-FST entity) 238 via SAPs 222 and 262 respectively, and MLME 288 in STA 265 may transmit data plane transition frames 546 to MLME 290 in STA 267. AP 403 and STA 410 may then exchange capability exchange confirmation 517 frames. For example, a component like MLME 248 and MLME 290 in AP 503 and STA 510 respectively, may exchange capability exchange confirmation 517 frames, wherein capability exchange confirmation 517 frames may comprise operational capabilities of AP 503 and STA 510. For instance, capability exchange confirmation 517 may comprise information about extended service sets (ESSs) that AP 503 belongs to, independent basic service sets (IBSSs) that AP 503 belongs to, and/or spectrum management data associated with MLME 248.

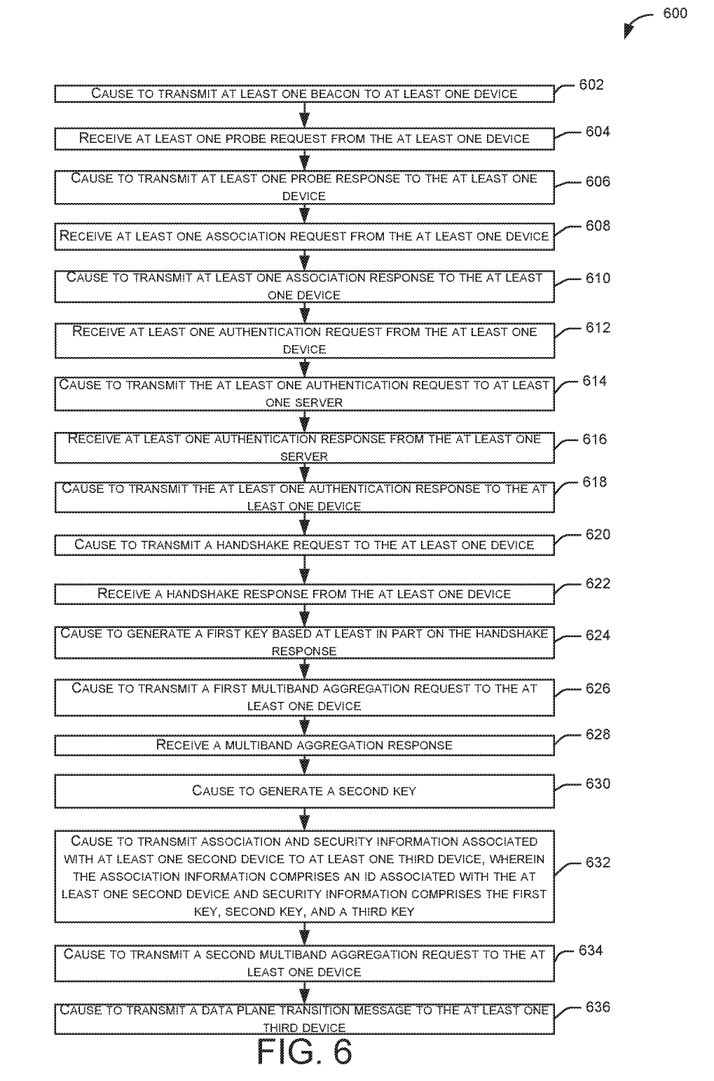

FIG. 6 depicts a flow diagram of an illustrative process for establishing a management plane connection with a device, according to one or more example embodiments of the disclosure. Method 600 may correspond to a series of steps that may occur in the order depicted in method 600 or in another order, and may correspond to computer-executable instructions that may be executed by a processor or one or more components in an access point, as depicted in FIG. 2A. At step 602, the method may cause to transmit at least one beacon to at least one device. The at least one beacon may be a signal that may be used by the least one device to synchronize with the transmitting device (e.g., AP). At step 604, the method may receive at least one probe request from the at least one device. The probe request may be a request for information about the transmitting device such as the SSID that the AP belongs to, supported rate, BSS, extended supported rates and BSS membership selectors, direct sequence spread spectrum (DSSS) parameters, supported operating classes, high throughput (HT) capabilities, SSSID list, channel usage, interworking, Mesh IDs, multi-band parameters, MAC sublayer information, very high throughput (VHT) capabilities, and vendor specific information. At step 606, the method may cause to transmit at least one probe response to the at least one device. The at least one probe response may include information associated with the information requested in the probe request. At step 608, the method may receive at least one association request from the at least one device. The association request may be a request to associated with the AP. At step 610, the method may cause to transmit at least one association response to the at least one device. The at least one association response may be a response permitting the at least one device to associate with the AP. At step 612, the method may receive at least one authentication request from the at least one device. The at least one authentication request may be a request for authentication according to the description of FIG. 3. At step 614, the method may cause to transmit the at least one authentication request to at least one server. The transmission of the at least one authentication request to the at least one server may be described in reference FIG. 3. At step 616, the method may receive at least one authentication response from the at least one server. The at least one authentication response from the at least one server may be described in reference to FIG. 3. At step 618, the method may cause to transmit the at least one authentication response to the at least one device. The transmission of the at least one authentication response to the at least one device may be described in reference to FIG. 3. At step 620, the method may cause to transmit a handshake request to the at least one device. The handshake request to the at least one device may be described in reference to FIG. 3. At step 622, the method may receive a handshake response from the at least one device. The handshake response to the at least one device may be described in reference to FIG. 3. At step 624, the method may cause to generate a first key based at least in part on the handshake response. At step 626, the method may cause to transmit a first multiband aggregation request to the at least one device, wherein a received signal strength indication (RSSI) threshold. The first multiband aggregation request may include one or more fields comprising recommendations of one or more 60 GHz APs, thresholds for triggering aggregation of one or more links (e.g., data plane links or management plane links), threshold parameters for link aggregation including parameters for splitting the management plane and data plane across two different access points and two different radios in the at least one device. At step 628, the method may receive a multiband aggregation response, wherein the multiband aggregation response may include a RSSI value. At step 630, the method may cause to generate a second key. At step 632, the method may cause to transmit association and security information associated with at least one second device to at least one third device, wherein the association information comprises an id associated with the at least one second device and security information comprises the first key, second key, and a third key. At step 634, the method may cause to transmit a second multiband aggregation request to the at least one device, wherein the second multiband aggregation request includes a management plane and data plane separation trigger. At step 636, the method may cause to transmit a data plane transition message to the at least one third device, wherein the data plane transition message includes a data plane transition trigger. The data plane transition message may cause data plane data to be transmitted between the at least one third device (e.g., a 60 GHz AP) and the at least one second device (e.g., 60 GHz STA).

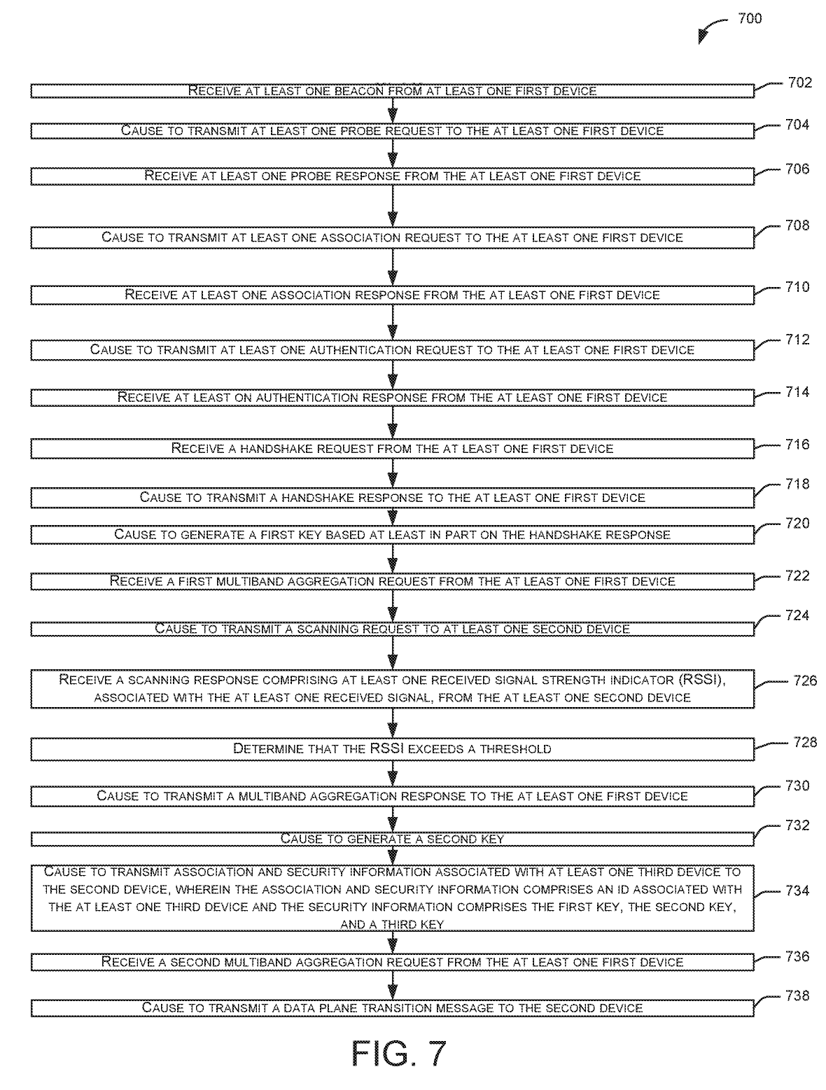

FIG. 7 depicts a flow diagram of an illustrative process for establishing a management plane connection with an access point, according to one or more example embodiments of the disclosure. Method 700 may correspond to a series of steps that may occur in the order depicted in method 700 or in another order, and may correspond to computer-executable instructions that may be executed by a processor or one or more components in a wireless device, as depicted in FIG. 2B. At step 702, the method may receive at least one beacon from the at least one first device. At step 704, the method may cause to transmit at least one probe request to the at least one first device. At step 706, the method may receive at least on probe response from the at least one first device. At step 708, the method may cause to transmit at least one association request to the at least one first device. At step 710, the method may receive at least one association response from the at least one first device. At step 712, the method may cause to transmit at least one authentication request to the at least one first device. At step 714, the method may receive at least one authentication response from the at least one first device. At step 716, the method may receive a handshake request from the at least one first device. At step 718, the method may cause to transmit a handshake response to the at least one first device. At step 720, the method may cause to generate a first key based at least in part on the handshake response. At step 722, the method may receive a first multiband aggregation request from the at least one first device. At step 724, the method may cause to transmit a scanning request to at least one second device. At step 726, the method may receive a scanning response comprising at least one received signal strength indicator (RSSI), associated with the at least one received signal, from the at least one second device. At step 728, the method may determine that the RSSI exceeds a threshold. At step 730, the method may cause to transmit a multiband aggregation response to the at least one first device. At step 732, the method may cause to generate a second key. At step 734, the method may cause to transmit association and security information associated with at least one third device to the second device, wherein the association and security information comprises an id associated with the at least one third device and the security information comprises the first key, the second key, and a third key. At step 736, the method may receive a second multiband aggregation request from the at least one first device. At step 738, the method cause to transmit a data plane transition message to the second device.

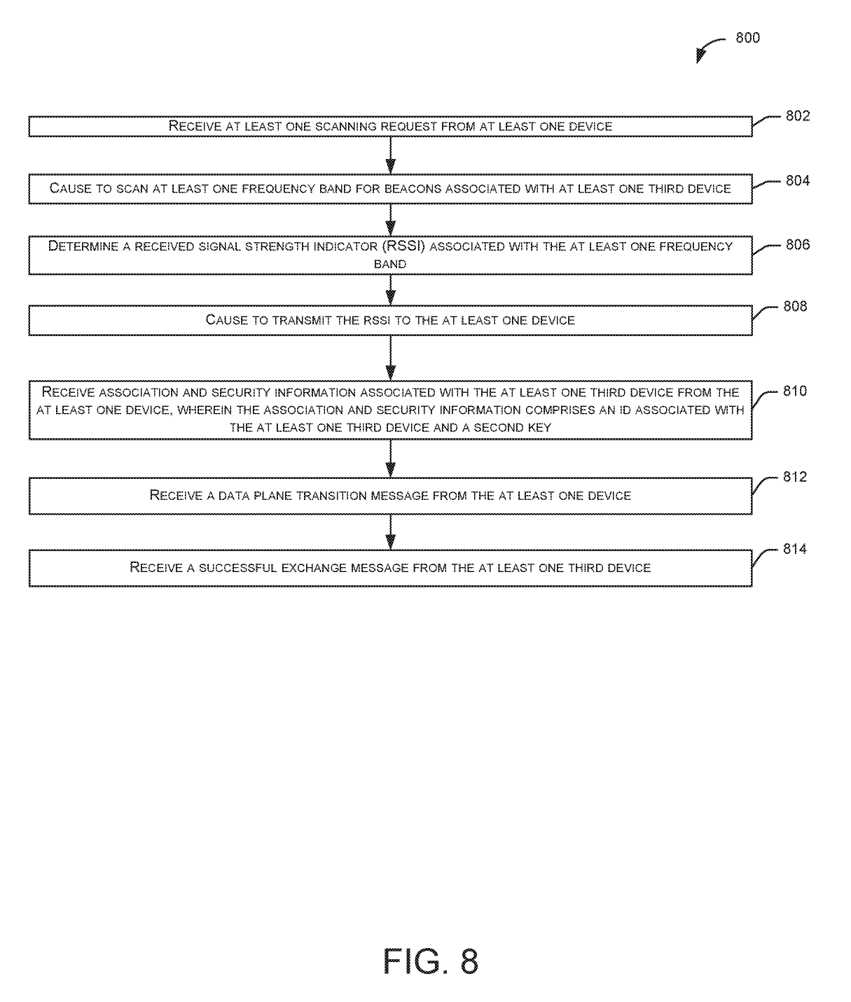

FIG. 8 depicts a flow diagram of an illustrative process for establishing a data plane connection with a device, according to one or more example embodiments of the disclosure. Method 800 may correspond to a series of steps that may occur in the order depicted in method 800 or in another order, and may correspond to computer-executable instructions that may be executed by a processor or one or more components in a wireless device, as depicted in FIG. 2B. At step 802, the method may receive at least one scanning request from at least one device. At step 804, the method may cause to scan at least one frequency band for beacons associated with at least one third device. At step 806, the method may determine a received signal strength indicator (RSSI) associated with the at least one frequency band. At step 808, the method may cause to transmit the RSSI to the at least one device. At step 810, the method may receive association and security information associated with the at least one third device from the at least one device, wherein the association and security information comprises an id associated with the at least one third device and a second key. At step 812, the method may receive a data plane transition message from the at least one device. At step 814, the method may receive a successful exchange message from the at least one third device.

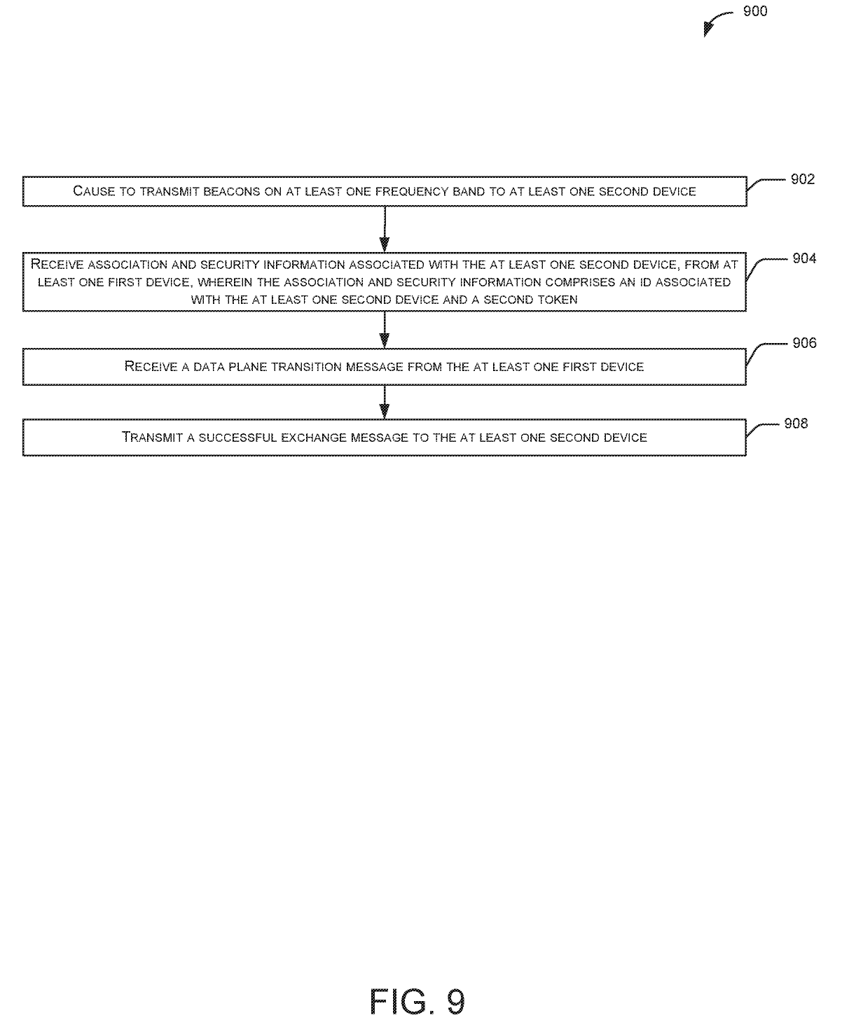

FIG. 9 depicts a flow diagram of an illustrative process for establishing a data plane connection with an access point, according to one or more example embodiments of the disclosure. Method 900 may correspond to a series of steps that may occur in the order depicted in method 900 or in another order, and may correspond to computer-executable instructions that may be executed by a processor or one or more components in an access point, as depicted in FIG. 2A. At step 902, the method may cause to transmit beacons on at least one frequency band to least one second device. At step 904, method receive association and security information associated with the at least one second device, from at least one first device, wherein the association and security information comprises an id associated with the at least one second device and a second token. At step 906, the method may receive a data plane transition message from the at least one first device. At step 908, the method may transmit a successful exchange message to the at least one second device.

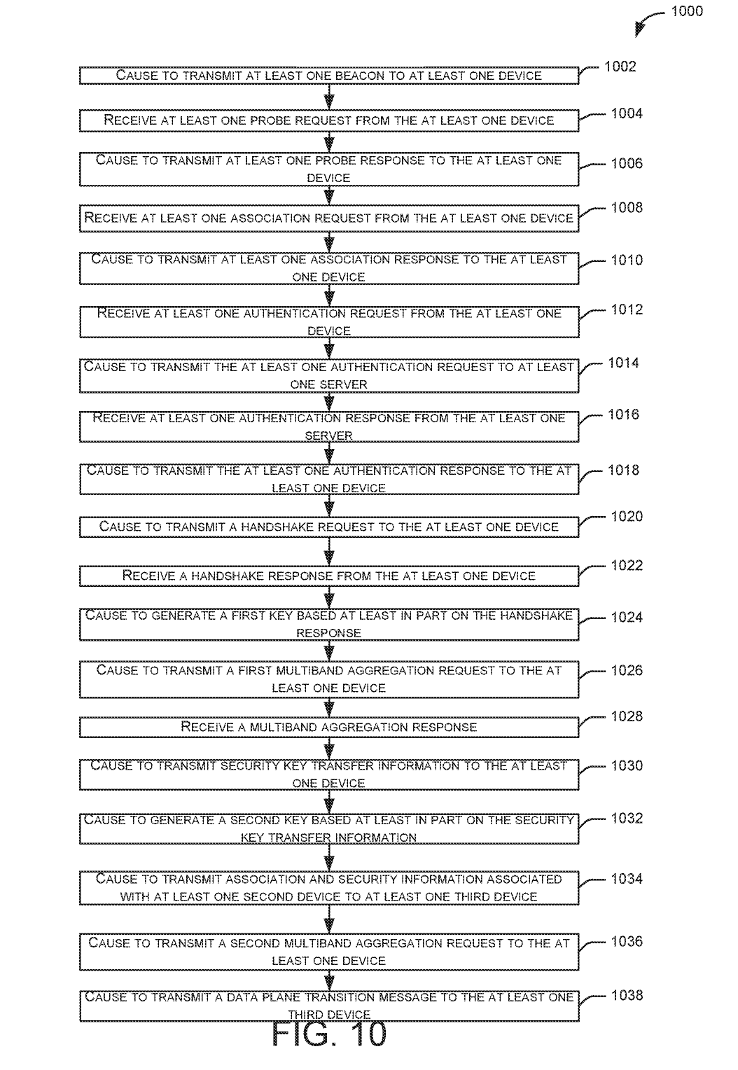

FIG. 10 depicts a flow diagram of an illustrative process for establishing a management plane connection with a device, according to one or more example embodiments of the disclosure. Method 1000 may correspond to a series of steps that may occur in the order depicted in method 1000 or in another order, and may correspond to computer-executable instructions that may be executed by a processor or one or more components in an access point, as depicted in FIG. 2A. At step 1002, the method may cause to transmit at least one beacon to at least one device. At step 1004, the method may receive at least one probe request from the at least one device. At step 1006, the method may cause to transmit at least one probe response to the at least one device. At step 1008, the method may receive at least one association request from the at least one device. At step 1010, the method may cause to transmit at least one association response to the at least one device. At step 1012, the method may receive at least one authentication request from the at least one device. At step 1014, the method may cause to transmit the at least one authentication request to at least one server. At step 1016, the method may receive at least one authentication response from the at least one server. At step 1018, the method may cause to transmit the at least one authentication response to the at least one device. At step 1020, the method may cause to transmit a handshake request to the at least one device. At step 1022, the method may receive a handshake response from the at least one device. At step 1024, the method may cause to generate a first key based at least in part on the handshake response. At step 1026, the method may cause to transmit a first multiband aggregation request to the at least one device. At step 1028, the method may receive a multiband aggregation response, wherein the multiband aggregation response may include a RSSI value. At step 1030, the method may cause to transmit security key transfer information to the at least one device. At step 1032, the method may cause to generate a second key based at least in part on the security key transfer information. At step 1034, the method may cause to transmit association and security information associated with at least one second device to at least one third device. At step 1036, the method may cause to transmit a second multiband aggregation request to the at least one device. At step 1038, the method may cause to transmit a data plane transition message to the at least one third device.

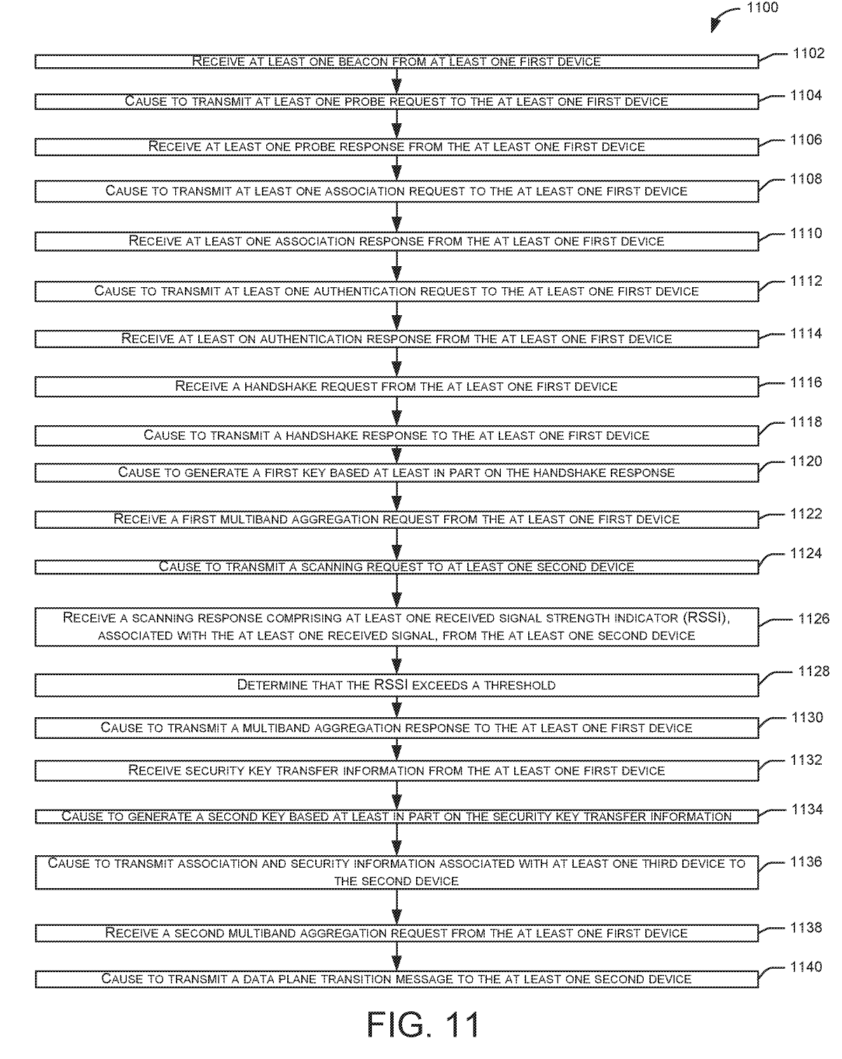

FIG. 11 depicts a flow diagram of an illustrative process for establishing a management plane connection with an access point, according to one or more example embodiments of the disclosure. Method 1100 may correspond to a series of steps that may occur in the order depicted in method 1100 or in another order, and may correspond to computer-executable instructions that may be executed by a processor or one or more components in an access point, as depicted in FIG. 2B. At step 1102, the method may receive at least one beacon from at least one first device. At step 1104, the method may cause to transmit at least one probe request to the at least one first device. At step 1106, the method may receive at least one probe response from the at least one first device. At step 1108, the method may cause to transmit at least one association request to the at least one first device. At step 1110, the method may receive at least one association response from the at least one first device. At step 1112, the method may cause to transmit at least one authentication request to the at least one first device. At step 1114, the method may receive at least one authentication response from the at least one first device. At step 1116, the method may receive a handshake request from the at least one first device. At step 1118, the method may cause to transmit a handshake response to the at least one first device. At step 1120, the method may cause to generate a first key based at least in part on the handshake response. At step 1122, the method may cause to receive a first multiband aggregation request from the at least one first device. At step 1124, the method may cause to transmit a scanning request to at least one second device. At step 1126, the method may receive a scanning response comprising at least one received signal strength indicator (RSSI), associated with the at least one received signal, from the at least one second device. At step 1128, the method may determine that the RSSI exceeds a threshold. At step 1130, the method may cause to transmit a multiband aggregation response to the at least one first device. At step 1132, the method may cause to receive security key transfer information from the at least one first device. At step 1134, the method may cause to generate a second key based at least in part on the security key transfer information. At step 1136, the method may cause to transmit association and security information associated with at least one third device to the second device. At step 1138, the method may receive a second multiband aggregation request from the at least one first device, wherein the second multiband aggregation request includes a management plane and data plane separation trigger. At step 1140, the method may cause to transmit a data plane transition message to the at least one second message, wherein the data plane transition message includes a data plane transition trigger.

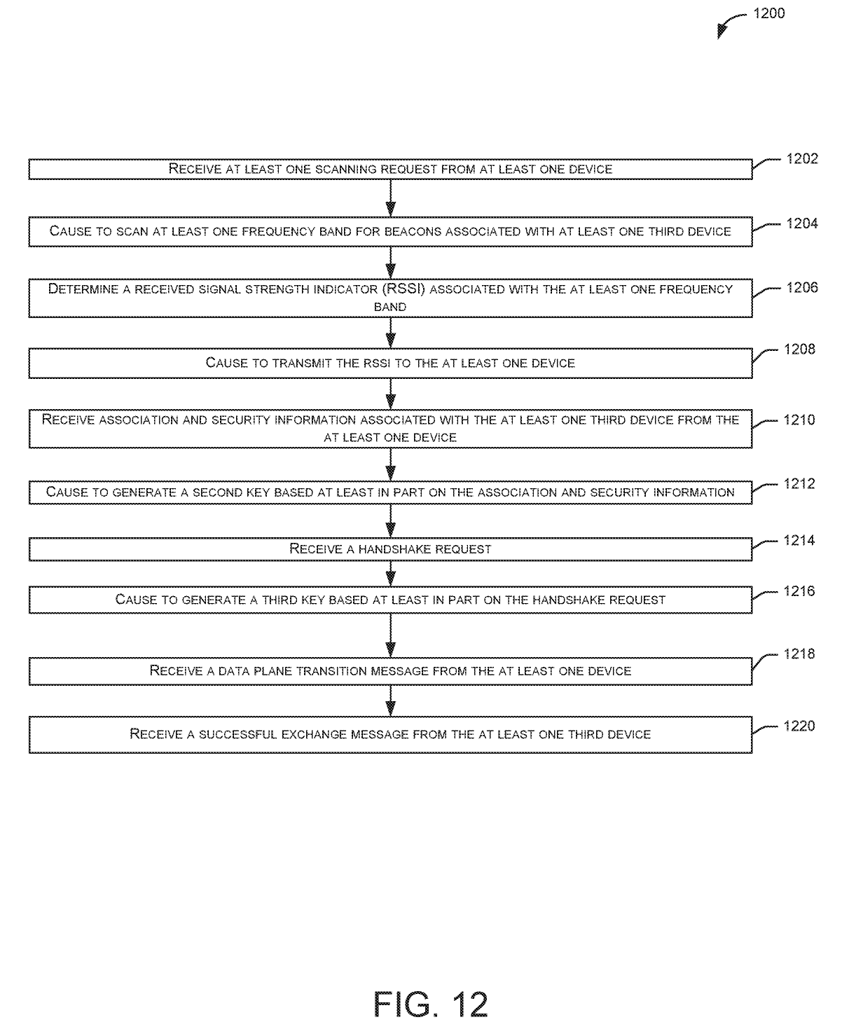

FIG. 12 depicts a flow diagram of an illustrative process for establishing a data plane connection with a device, according to one or more example embodiments of the disclosure. Method 1200 may correspond to a series of steps that may occur in the order depicted in method 1200 or in another order, and may correspond to computer-executable instructions that may be executed by a processor or one or more components in an access point, as depicted in FIG. 2B. At step 1202, the method may receive at last one scanning request from at least one device. At step 1204, the method may cause to scan at least one frequency band for beacons associated with at least one third device. At step 1206, the method may determine a received signal strength indicator (RSSI) associated with the at least one frequency band. At step 1208, the method may cause to transmit the RSSI to the at least one device. At step 1210, the method may receive association and security information associated with the at least one third device from the at least one device. At step 1212, the method may cause to generate a second key based at least in part on the association and security information. At step 1214, the method may receive a handshake request. At step 1216, the method may cause to generate a third key based at least in part on the handshake request. At step 1218, the method may receive a data plane transition message from the at least one device. At step 1220, the method may receive a successful exchange message from the at least one third device.

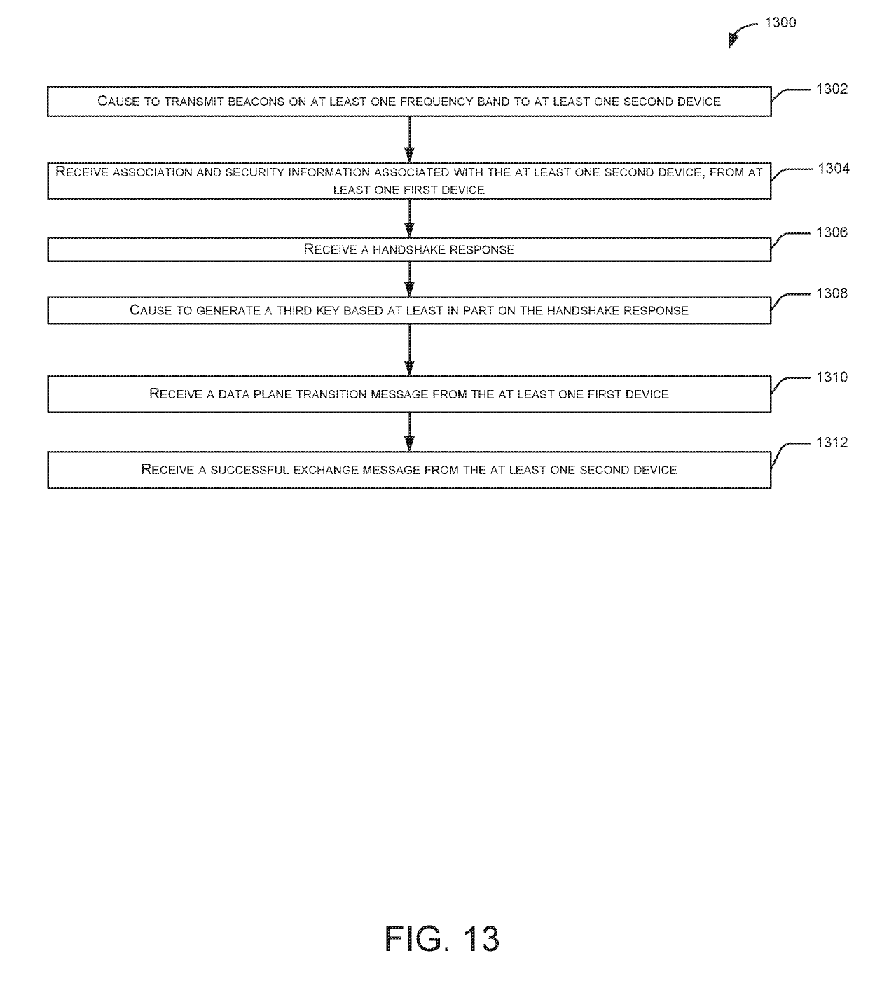

FIG. 13 depicts a flow diagram of an illustrative process for establishing a data plane connection with an access point, according to one or more example embodiments of the disclosure. Method 1300 may correspond to a series of steps that may occur in the order depicted in method 1300 or in another order, and may correspond to computer-executable instructions that may be executed by a processor or one or more components in an access point, as depicted in FIG. 2A. At step 1302, the method may cause to transmit beacons on at least one frequency band to at least one second device. At step 1304, the method may receive association and security information associated with the at least one second device, from at least one first device. At step 1306, the method may receive a handshake request. At step 1308, the method may cause to generate a third key based at least in part on the handshake response. At step 1310, the method may receive a data plane transition message from the at least one first device. At step 1312, the method may receive a successful exchange message from the at least one second device.

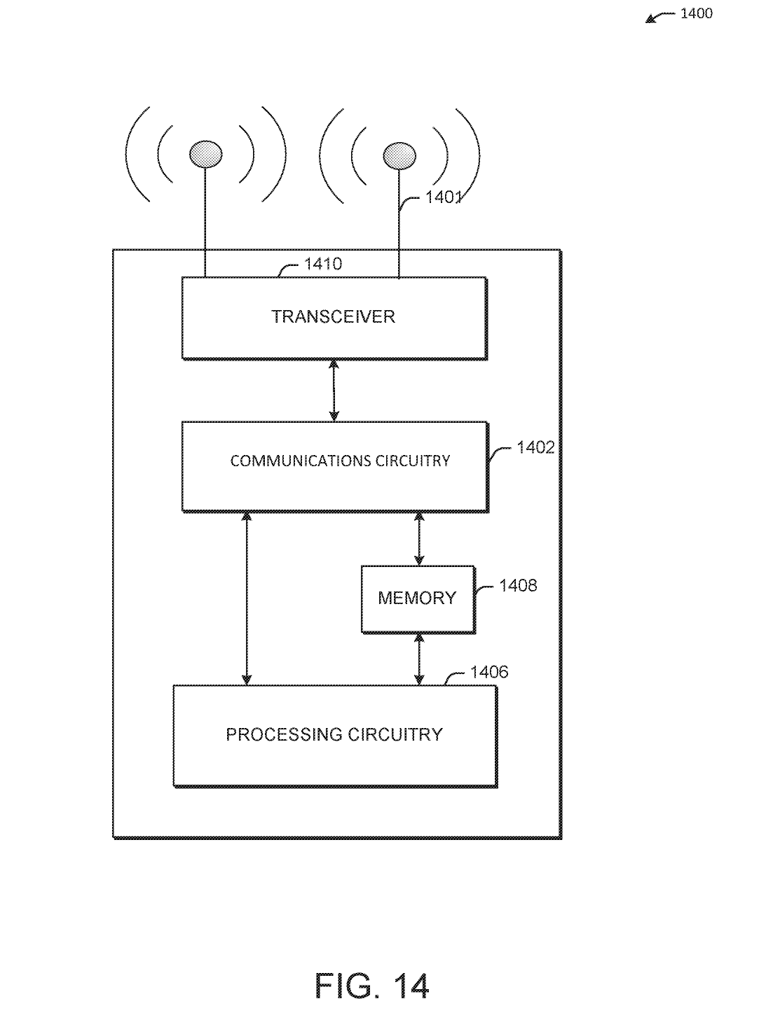

FIG. 14 shows a functional diagram of an exemplary communication station 1400 in accordance with some embodiments. In one embodiment, FIG. 14 illustrates a functional block diagram of a communication station that may be suitable for use as an AP (e.g., APs 102, 104, 108, 110) in FIG. 1 or at least one user device (e.g., user device 114) in FIG. 1 in accordance with some embodiments. The communication station 700 may also be suitable for use as a handheld device, mobile device, cellular telephone, smartphone, tablet, netbook, wireless terminal, laptop computer, wearable computer device, femtocell, HiGH Data Rate (HDR) subscriber station, access point, access terminal, or other personal communication system (PCS) device.

The communication station 1400 may include communications circuitry 1402 and a transceiver 1410 for transmitting and receiving signals to and from other communication stations using one or more antennas 1401. The communications circuitry 1402 may include circuitry that can operate the physical layer communications and/or medium access control (MAC) communications for controlling access to the wireless medium, and/or any other communications layers for transmitting and receiving signals. The communication station 1400 may also include processing circuitry 1406 and memory 1408 arranged to perform the operations described herein. In some embodiments, the communications circuitry 1402 and the processing circuitry 1406 may be configured to perform operations detailed in FIGS. 2-9.

In accordance with some embodiments, the communications circuitry 1402 may be arranged to contend for a wireless medium and configure frames or packets for communicating over the wireless medium. The communications circuitry 1402 may be arranged to transmit and receive signals. The communications circuitry 1402 may also include circuitry for modulation/demodulation, upconversion/downconversion, filtering, amplification, etc. In some embodiments, the processing circuitry 1406 of the communication station 1400 may include one or more processors. In other embodiments, two or more antennas 1401 may be coupled to the communications circuitry 1402 arranged for sending and receiving signals. The memory 1408 may store information for configuring the processing circuitry 1406 to perform operations for configuring and transmitting message frames and performing the various operations described herein. The memory 1408 may include any type of memory, including non-transitory memory, for storing information in a form readable by a machine (for example, a computer). For example, the memory 1408 may include a computer-readable storage device may, read-only memory (ROM), random-access memory (RAM), magnetic disk storage media, optical storage media, flash-memory devices and other storage devices and media.

In some embodiments, the communication station 1400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (for example, a heart rate monitor, a blood pressure monitor, etc.), a wearable computer device, or another device that may receive and/or transmit information wirelessly.

In some embodiments, the communication station 1400 may include one or more antennas 1401. The antennas 1401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1400 may include one or more of a keyboard, a display, a non-volatile memory port, multiple antennas, a graphics processor, an application processor, speakers, and other mobile device elements. The display may be an LCD screen including a touch screen.

Although the communication station 1400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (for example, a computer). For example, a computer-readable storage device may include read-only memory (ROM), random-access memory (RAM), magnetic disk storage media, optical storage media, flash-memory devices, and other storage devices and media. In some embodiments, the communication station 1400 may include one or more processors and may be configured with instructions stored on a computer-readable storage device memory.

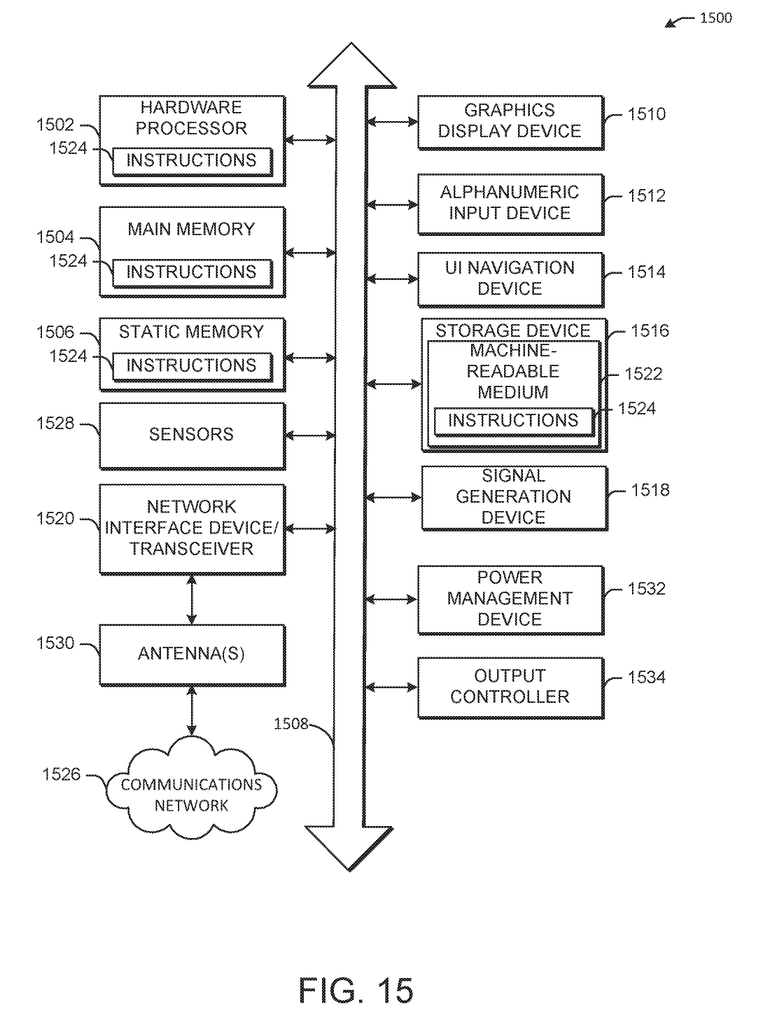

FIG. 15 illustrates a block diagram of an example of a machine 1500 or system upon which any one or more of the techniques (for example, methodologies) discussed herein may be performed, such as described with reference to the timing diagrams and process flows of FIGS. 4-14. In embodiments, the machine 1500 may be an access point, wireless device or other device as depicted and described herein, for example, with reference to FIGS. 1-3. In other embodiments, the machine 1500 may operate as a standalone device or may be connected (for example, networked) to other machines. In a networked deployment, the machine 1500 may operate in the capacity of a server machine, a client machine, or both in server-client network environments. In an example, the machine 1500 may act as a peer machine in peer-to-peer (P2P) (or other distributed) network environments. The machine 1500 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (for example, hardware) capable of performing specified operations when operating. A module includes hardware. In an example, the hardware may be specifically configured to carry out a specific operation (for example, hardwired). In another example, the hardware may include configurable execution units (for example, transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (for example, computer system) 1500 may include a hardware processor 1502 (for example, a central processing unit (CPU), a graphics processing unit (GPU), a hardware processor core, or any combination thereof), a main memory 1504 and a static memory 1506, some or all of which may communicate with each other via an interlink (for example, bus) 1508. The machine 1500 may further include a power management device 1532, a graphics display device 1510, an alphanumeric input device 1512 (for example, a keyboard), and a user interface (UI) navigation device 1514 (for example, a mouse). In an example, the graphics display device 1510, alphanumeric input device 1512, and UI navigation device 1514 may be a touch screen display. The machine 1500 may additionally include a storage device (i.e., drive unit) 1516, a signal generation device 1518 (for example, a speaker), an aggregation and enhanced transmission of small packets device 1519, a network interface device/transceiver 1520 coupled to antenna(s) 1530, and one or more sensors 1528, such as a global positioning system (GPS) sensor, compass, accelerometer, or other sensor. The machine 1500 may include an output controller 1534, such as a serial (for example, universal serial bus (USB), parallel, or other wired or wireless (for example, infrared (IR), near field communication (NFC), etc.) connection to communicate with or control one or more peripheral devices (for example, a printer, card reader, etc.)).

The storage device 1516 may include a machine readable medium 1522 on which is stored one or more sets of data structures or instructions 1524 (for example, software) embodying or utilized by any one or more of the techniques or functions described herein. The instructions 1524 may also reside, completely or at least partially, within the main memory 1504, within the static memory 1506, or within the hardware processor 1502 during execution thereof by the machine 1500. In an example, one or any combination of the hardware processor 1502, the main memory 1504, the static memory 1506, or the storage device 1516 may constitute machine-readable media.

The instructions 1524 may carry out or perform any of the operations and processes (for example, processes 300-1300) described and shown above. While the machine-readable medium 1522 is illustrated as a single medium, the term “machine-readable medium” may include a single medium or multiple media (for example, a centralized or distributed database, and/or associated caches and servers) configured to store the one or more instructions 1524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1500 and that cause the machine 1500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (for example, Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1524 may further be transmitted or received over a communications network 1526 using a transmission medium via the network interface device/transceiver 1520 utilizing any one of a number of transfer protocols (for example, frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (for example, the Internet), mobile telephone networks (for example, cellular networks), Plain Old Telephone (POTS) networks, wireless data networks (for example, Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1520 may include one or more physical jacks (for example, Ethernet, coaxial, or phone jacks) or one or more antennas to connect to the communications network 1526. In an example, the network interface device/transceiver 1520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1500 and includes digital or analog communications signals or other intangible media to facilitate communication of such software. The operations and processes (for example, processes 600-900) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, HiGH Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, for example, a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), time-Division Multiplexing (TDM), time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

In example embodiments of the disclosure, there may be a device, comprising a memory and processing circuitry configured to: cause to send at least one beacon to at least one device; identify at least one probe request received from the at least one device; cause to send at least one probe response to the at least one device; identify at least one association request received from the at least one device; cause to send at least one association response to the at least one device; cause to send at least one handshake request to the at least one device; identify at least one handshake response received from the at least one device; cause to send a first multiband aggregation request to the at least one device, the multiband aggregation request including a received signal strength indication (RSSI) threshold; identify a multiband aggregation response received from the at least one device, the multiband response including at least one RSSI value; cause to send association and security information associated with at least one second device to at least one third device; cause to send a second multiband aggregation request to the at least one third device, the second multiband aggregation request including a management plane and data plane separation trigger; and cause to send a data plane transition message to the at least one third device, the data plane transition message including a data plane transition trigger.

Implementations may include the following features. The first multiband aggregation request may comprise the identification associated with the at least one second device. The RSSI threshold may correspond to a trigger for the processing circuitry to cause to send the data plane transition message to the at least one third device. The first multiband aggregation request may comprise at least one parameter associated with establishing a first link between the device and the at least one first device, and establishing a second link between the at least one second device and the at least one third device. The first link may correspond to a management plane link, and management data may be transferred to the at least one first device using the management plane link. The management data may be transferred to the at least one first device on a 5 Gigahertz (GHz) frequency and data plane data may be transferred to the at least one second device on a 60 Gigahertz (GHz) frequency. The RSSI value may be greater than the RSSI threshold. The wireless device may further comprise a transceiver that may be configured to send and receive wireless signals. The wireless device may further comprise an antenna coupled to the transceiver.

In some example embodiments of this disclosure, there may be a non-transitory computer-readable medium storing computer-executable instructions which, when executed by a processor, cause the processor to perform operations comprising: causing to send at least one beacon to at least one device; identifying at least one probe request received from the at least one device; causing to send at least one probe response to the at least one device; identifying at least one association request received from the at least one device; causing to send at least one association response to the at least one device; causing to send at least one handshake request to the at least one device; identifying at least one handshake response received from the at least one device; causing to send a first multiband aggregation request to the at least one device, the multiband aggregation request including a received signal strength indication (RSSI) threshold; identifying a multiband aggregation response received from the at least one second device, the multiband response including a RSSI value; causing to send association and security information associated with at least one second device to at least one third device; causing to send a second multiband aggregation request to the at least one third device, the second multiband aggregation request including a management plane and data plane separation trigger; and causing to send a data plane transition message to the at least one third device, the data plane transition message including a data plane transition trigger.

Implementations may include the following features. The first multiband aggregation request may comprise the identification associated with the at least one second device. The RSSI threshold may correspond to a trigger for the processor to cause to send the data plane transition message to the at least one third device. The first multiband aggregation request may comprise at least one parameter associated with establishing a first link between the device and the at least one first device, and establishing a second link between the at least one second device and the at least one third device. The first link may correspond to a management plane link, and management data may be transferred to the at least one first device using the management plane link. The RSSI value may be greater than the RSSI threshold.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1. A device, the device comprising:
memory and processing circuitry configured to:
cause to send at least one beacon to at least one device;
identify at least one probe request received from the at least one device;
cause to send at least one probe response to the at least one device;
identify at least one association request received from the at least one device;
cause to send at least one association response to the at least one device;
cause to send at least one handshake request to the at least one device;
identify at least one handshake response received from the at least one device;
cause to send a first multiband aggregation request to the at least one device, the first multiband aggregation request including a received signal strength indication (RSSI) threshold;
identify a multiband aggregation response received from the at least one device, the multiband aggregation response including at least one RSSI value;
cause to send association and security information associated with at least one second device to at least one third device;
cause to send a second multiband aggregation request to the at least one third device, the second multiband aggregation request including a management plane and data plane separation trigger; and
cause to send a data plane transition message to the at least one third device, the data plane transition message including a data plane transition trigger.

2. The device of claim 1, wherein the first multiband aggregation request comprises an identification associated with the at least one second device.

3. The device of claim 1, wherein the RSSI threshold corresponds to a trigger for the processing circuitry to cause to send the data plane transition message to the at least one third device.

4. The device of claim 1, wherein the first multiband aggregation request comprises at least one parameter associated with establishing a first link between the device and the at least one first device, and establishing a second link between the at least one second device and the at least one third device.

5. The device of claim 4, wherein the first link corresponds to a management plane link, and management data is transferred to the at least one first device using the management plane link.

6. The device of claim 5, wherein the management data is transferred to the at least one first device on a 5 Gigahertz (GHz) frequency and data plane data is transferred to the at least one second device on a 60 Gigahertz GHz frequency.

7. The device of claim 1, wherein the RSSI value is greater than the RSSI threshold.

8. The device of claim 1, further comprising a transceiver configured to send and receive wireless signals.

9. The device of claim 8, further comprising an antenna coupled to the transceiver.

10. A non-transitory computer-readable medium storing computer-executable instructions which, when executed by a processor, cause the processor to perform operations comprising:
causing to send at least one beacon to at least one device;
identifying at least one probe request received from the at least one device;
causing to send at least one probe response to the at least one device;
identifying at least one association request received from the at least one device;
causing to send at least one association response to the at least one device;
causing to send at least one handshake request to the at least one device;
identifying at least one handshake response received from the at least one device;
causing to send a first multiband aggregation request to the at least one device, the first multiband aggregation request including a received signal strength indication (RSSI) threshold;
identifying a multiband aggregation response received from the at least one second device, the multiband aggregation response including a RSSI value;
causing to send association and security information associated with at least one second device to at least one third device;
causing to send a second multiband aggregation request to the at least one third device, the second multiband aggregation request including a management plane and data plane separation trigger; and
causing to send a data plane transition message to the at least one third device, the data plane transition message including a data plane transition trigger.

11. The non-transitory computer-readable medium of claim 10, wherein the first multiband aggregation request comprises the identification associated with the at least one second device.

12. The non-transitory computer-readable medium of claim 10, wherein the RSSI threshold corresponds to a trigger for the processor to cause to send the data plane transition message to the at least one third device.

13. The non-transitory computer-readable medium of claim 10, wherein the first multiband aggregation request comprises at least one parameter associated with establishing a first link between the device and the at least one first device, and establishing a second link between the at least one second device and the at least one third device.

14. The non-transitory computer-readable medium of claim 13, wherein the first link corresponds to a management plane link, and management data is transferred to the at least one first device using the management plane link.

15. The non-transitory computer-readable medium of claim 10, wherein the RSSI value is greater than the RSSI threshold.

16. A method comprising:
causing to send at least one beacon to at least one device;
identifying at least one probe request received from the at least one device;
causing to send at least one probe response to the at least one device;
identifying at least one association request received from the at least one device;
causing to send at least one association response to the at least one device;
causing to send at least one handshake request to the at least one device;
identifying at least one handshake response received from the at least one device;
causing to send a first multiband aggregation request to the at least one second device, the first multiband aggregation request including a received signal strength indication (RSSI) threshold;
identifying a multiband aggregation response received from the at least one second device, the multiband aggregation response including a RSSI value;
causing to send association and security information associated with at least one second device to at least one third device;
causing to send a second multiband aggregation request to the at least one third device, the second multiband aggregation request including a management plane and data plane separation trigger; and
causing to send a data plane transition message to the at least one third device, the data plane transition message including a data plane transition trigger.

17. The method of claim 16, wherein the first multiband aggregation request comprises the identification associated with the at least one second device.

18. The method of claim 16, wherein the RSSI threshold corresponds to a trigger for causing to send the data plane transition message to the at least one third device.

19. The method of claim 16, wherein the first multiband aggregation request comprises at least one parameter associated with establishing a first link between the device and the at least one first device, and further comprising establishing a second link between the at least one second device and the at least one third device.

20. The method of claim 19, wherein the first link corresponds to a management plane link, and management data is transferred to the at least one first device using the management plane link.
